(19) United States
(12) Patent Application Publication
(10) Pub. No.: US 2010/0128896 A1
(43) Pub. Date: May 27, 2010

(54) SOUND RECEIVING DEVICE, DIRECTIONAL CHARACTERISTIC DERIVING METHOD, DIRECTIONAL CHARACTERISTIC DERIVING APPARATUS AND COMPUTER PROGRAM

(75) Inventor: Shoji HAYAKAWA, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 12/695,467

(22) Filed: Jan. 28, 2010

Related U.S. Application Data
(63) Continuation of application No. PCT/JP2007/065271, filed on Aug. 3, 2007.

(51) Int. Cl. H04B 15/00; H04R 3/00

(52) U.S. Cl. 381/92; 381/94.1

(57) ABSTRACT

A sound receiving device 1 having a housing 10 in which a plurality of sound receiving units which can receive sounds arriving from a plurality of directions are arranged, includes an omni-directional main sound receiving unit 11 and a sub-sound receiving unit 12 arranged at a position to receive a sound, arriving from a direction other than a given direction, earlier by a given time than the time at which the main sound receiving unit 11 receives the sound. With respect to the received sounds, the sound receiving device calculates a time difference, as a delay time, between the sound receiving time of the sub-sound receiving unit 11 and the sound receiving time of the main sound receiving unit 12.

### CROSS-REFERENCE TO RELATED APPLICATIONS

This application is the continuation, filed under 35 U.S.C. §111(a), of PCT International Application No. PCT/JP2007/065271 which has an International filing date of Aug. 3, 2007 and designated the United States of America.

### FIELD

The present invention relates to a sound receiving device having a housing in which a plurality of sound receiving units which may receive sounds arriving from a plurality of directions are arranged.

### BACKGROUND

When a sound receiving device such as a mobile phone in which a microphone is arranged is designed to have directivity only toward the mouth of a speaker, it is necessary to use a directional microphone. A sound receiving device in which a plurality of microphones including a directional microphone are arranged in a housing to realize a stronger directivity in a signal processing such as synchronous subtraction has been developed.

For example, in U.S. Patent Application Publication No. 2003/0044025, a mobile phone in which a microphone array obtained by combining a directional microphone and an omni-directional microphone is arranged to strengthen directivity toward a mouth which corresponds to a front face of the housing is disclosed.

In Japanese Laid-Open Patent Publication No. 08-256196, a device in which a directional microphone is arranged on a front face of a housing, and a directional microphone is arranged on a bottom face of the housing to reduce noise, which is received by the directional microphone on the bottom face and arriving from directions other than a direction of the mouth, from a sound received by the directional microphone on the front face so as to strengthen a directivity toward the mouth is disclosed.

### SUMMARY

According to an aspect of the embodiments, a devise includes a sound receiving device including a housing in which a plurality of omni-directional sound receiving units which is able to receive sounds arriving from a plurality of directions are arranged, includes:

at least one main sound receiving unit;

at least one sub-sound receiving unit arranged at a position to receive a sound, arriving from a direction other than a given direction, earlier by a given time than the time when the main sound receiving unit receives the sound;

a calculation unit which, with respect to the received sounds, calculates a time difference, as a delay time, between a sound receiving time of the sub-sound receiving unit and a sound receiving time of the main sound receiving unit; and

a suppression enhancement unit which carries out suppression of the sound received by the main sound receiving unit in the case where the calculated delay time is no less than a threshold and/or enhancement of the sound received by the main sound receiving unit in the case where the calculated delay time is shorter than the threshold.

The object and advantages of the invention will be realized and attained by the elements and combinations particularly pointed out in the claims. It is to be understood that both the foregoing general description and the following detailed description are exemplary and explanatory and are not restrictive of the embodiment, as claimed.

### BRIEF DESCRIPTION OF THE DRAWINGS

FIG. 1 is an explanatory diagram illustrating an outline of a sound receiving device according to Embodiment 1.

FIGS. 2A to C represent a trihedral diagram illustrating an example of an appearance of the sound receiving device according to Embodiment 1.

FIG. 3 is a table illustrating an example of sizes of the sound receiving device according to Embodiment 1.

FIG. 4 is a block diagram illustrating one configuration of the sound receiving device according to Embodiment 1.

FIG. 5 is a functional block diagram illustrating an example of a functional configuration of the sound receiving device according to Embodiment 1.

FIGS. 6A and 6B are graphs illustrating examples of a phase difference spectrum of the sound receiving device according to Embodiment 1.

FIG. 7 is a graph illustrating an example of a suppression coefficient of the sound receiving device according to Embodiment 1.

FIG. 8 is a flow chart illustrating an example of processes of the sound receiving device according to Embodiment 1.

FIG. 9 is an explanatory diagram illustrating an outline of a measurement environment of a directional characteristic of the sound receiving device according to Embodiment 1.

FIGS. 10A and 10B are measurement results of a horizontal directional characteristic of the sound receiving device according to Embodiment 1.

FIGS. 11A and 11B are measurement results of a vertical directional characteristic of the sound receiving device according to Embodiment 1.

FIGS. 12A to 12C are trihedral diagrams illustrating examples of appearances of the sound receiving device according to Embodiment 1.

FIG. 13 is a perspective view illustrating an example of a reaching path of a sound signal, which is assumed with respect to a sound receiving device according to Embodiment 2.

FIGS. 14A and 14B are upper views illustrating examples of reaching paths of sound signals, which is assumed with respect to the sound receiving device according to Embodiment 2.

FIG. 15 is an upper view conceptually illustrating a positional relation in 0≦θ<π/2 between a virtual plane and the sound receiving device according to Embodiment 2.

FIG. 16 is an upper view conceptually illustrating a positional relation in π/2≦θ<π between the virtual plane and the sound receiving device according to Embodiment 2.

FIG. 17 is an upper view conceptually illustrating a positional relation in π≦θ<3π/2 between the virtual plane and the sound receiving device according to Embodiment 2.

FIG. 18 is an upper view conceptually illustrating a positional relation in 3π/2≦θ<2π between the virtual plane and the sound receiving device according to Embodiment 2.

FIGS. 19A and 19B are radar charts illustrating a horizontal directional characteristic of the sound receiving device according to Embodiment 2.

FIGS. 20A and 20B are radar charts illustrating a horizontal directional characteristic of the sound receiving device according to Embodiment 2.

FIG. 21 is a side view conceptually illustrating a positional relation in 0≦θ<π/2 between a virtual plane and the sound receiving device according to Embodiment 2.

FIG. 22 is a side view conceptually illustrating a positional relation in π/2≦θ<π between the virtual plane and the sound receiving device according to Embodiment 2.

FIG. 23 is a side view conceptually illustrating a positional relation in π≦θ<3π/2 between the virtual plane and the sound receiving device according to Embodiment 2.

FIG. 24 is a side view conceptually illustrating a positional relation in 3π/2≦θ<2π between the virtual plane and the sound receiving device according to Embodiment 2.

FIGS. 25A and 25B are radar charts illustrating a vertical directional characteristic of the sound receiving device according to Embodiment 2.

FIG. 26 is a block diagram illustrating one configuration of a directional characteristic deriving apparatus according to Embodiment 2.

FIG. 27 is a flow chart illustrating processes of the directional characteristic deriving apparatus according to Embodiment 2.

FIG. 28 is a block diagram illustrating one configuration of a sound receiving device according to Embodiment 3.

FIG. 29 is a flow chart illustrating an example of processes of the sound receiving device according to Embodiment 3.

### DESCRIPTION OF EMBODIMENTS

### Embodiment 1

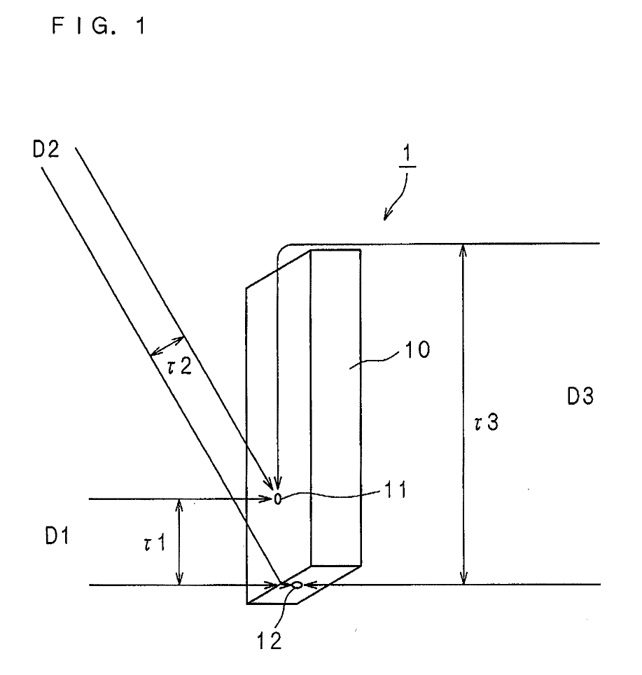

FIG. 1 is an explanatory diagram illustrating an outline of a sound receiving device according to Embodiment 1. A sound receiving device 1 includes a rectangular parallelepiped housing 10 as illustrated in FIG. 1. The front face of the housing 10 is a sound receiving face on which a main sound receiving unit 11 such as an omni-directional microphone is arranged to receive a voice uttered by a speaker. On a bottom face serving as one of contact faces being in contact with a front face (sound receiving face), a sub-sound receiving unit 12 such as a microphone is arranged.

Sounds from various directions arrive at the sound receiving device 1. For example, a sound arriving from a direction of the front face of the housing 10, indicated as an arriving direction D1, directly reaches the main sound receiving unit 11 and the sub-sound receiving unit 12. Therefore, a delay time τ1 representing a time difference between a reaching time for the sub-sound receiving unit 12 and a reaching time for the main sound receiving unit 11 is given as a time difference depending on a distance corresponding to a depth between the main sound receiving unit 11 arranged on a front face and the sub-sound receiving unit 12 arranged on a bottom face.

Although a sound arriving from a diagonally upper side (for example, indicated as an arriving direction D2) of the front face of the housing 10 directly reaches the main sound receiving unit 11, the sound reaches the housing 10 and then passes through a bottom face before reaching the sub-sound receiving unit 12. Therefore, since a path length of a path reaching the sub-sound receiving unit 12 is longer than a path length of a path reaching the main sound receiving unit 11, a delay time τ2 representing a time difference between a reaching time for the sub-sound receiving unit 12 and a reaching time for the main sound receiving unit 11 takes a negative value.

Furthermore, for example, a sound arriving from a direction of a back face of the housing 10 (for example, indicated as an arriving direction D3) is diffracted along the housing 10 and passes through the front face before reaching the main sound receiving unit 11, while the sound directly reaches the sub-sound receiving unit 12. Therefore, since the path length of the path reaching the sub-sound receiving unit 12 is shorter than the path length of the path reaching the main sound receiving unit 11, a delay time τ3 representing a time difference between the reaching time for the sub-sound receiving unit 12 and the reaching time for the main sound receiving unit 11 takes a positive value. The sound receiving device 1 according to the present embodiment suppresses a sound reaching from a direction other than a specific direction based on the time difference to realize the sound receiving device 1 having a directivity.

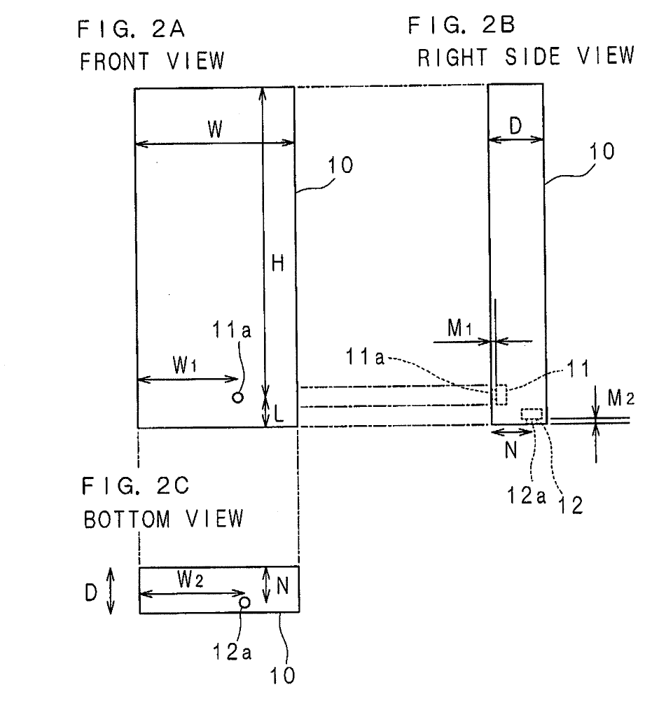

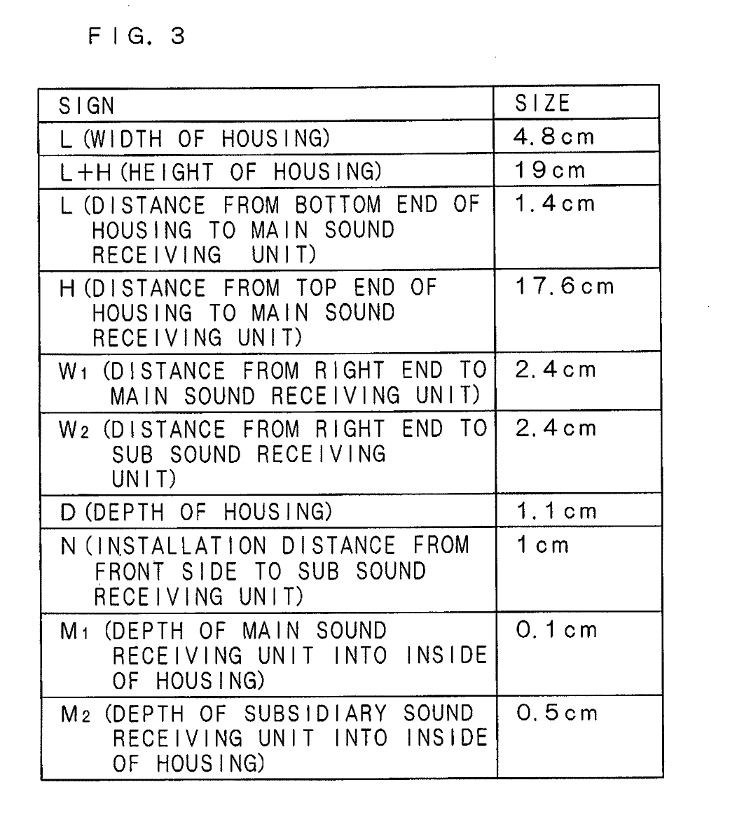

FIG. 2 is a trihedral diagram illustrating an example of an appearance of the sound receiving device 1 according to Embodiment 1. FIG. 3 is a table illustrating an example of the size of the sound receiving device 1 according to Embodiment 1. FIG. 2A is a front view, FIG. 2B is a side view, and FIG. 2C is a bottom view. FIG. 3 represents the size of the sound receiving device 1 illustrated in FIG. 2 and arrangement positions of the main sound receiving unit 11 and the sub-sound receiving unit 12. As illustrated in FIGS. 2 and 3, the main sound receiving unit 11 is arranged at a lower right position on the front face of the housing 10 of the sound receiving device 1, and an opening 11a for causing the main sound receiving unit 11 to receive a sound is formed at the arrangement position of the main sound receiving unit 11. More specifically, the sound receiving device is designed to cause the main sound receiving unit 11 to be close to the mouth of a speaker when the speaker holds the sound receiving device 1 by a general how to grasp. The sub-sound receiving unit 12 is arranged on the bottom face of the housing 10 of the sound receiving device 1, and an opening 12a for causing the sub-sound receiving unit 12 to receive a sound is formed at the arrangement position of the sub-sound receiving unit 12. When the speaker holds the sound receiving device 1 by the general how to grasp, the opening 12a is not covered with a hand of the speaker.

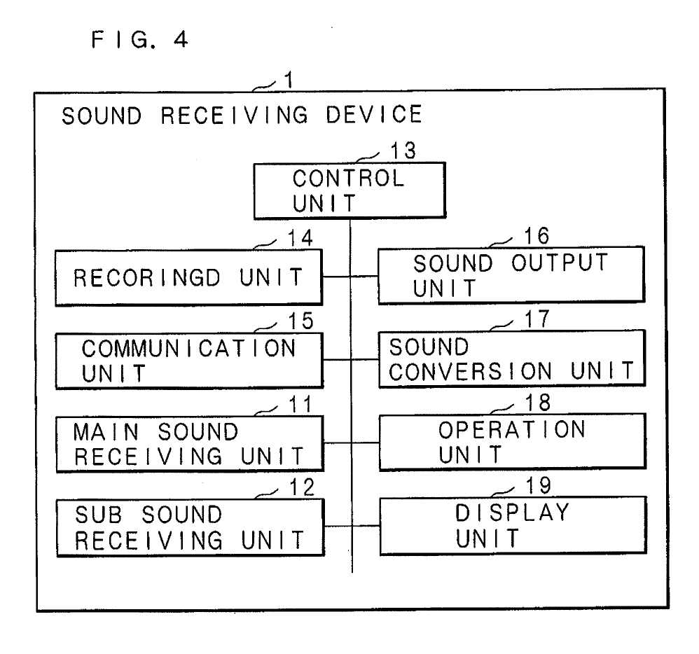

An internal configuration of the sound receiving device 1 will be described below. FIG. 4 is a block diagram illustrating one configuration of the sound receiving device 1 according to Embodiment 1. The sound receiving device 1 includes a control unit 13 such as a CPU which controls the device as a whole, a recording unit 14 such as a ROM or a RAM which records a computer program executed by the control of the control unit 13 and information such as various data, and a communication unit 15 such as an antenna serving as a communication interface and its ancillary equipment. The sound receiving device 1 includes the main sound receiving unit 11 and the sub-sound receiving unit 12 in which omni-directional microphones are used, a sound output unit 16, and a sound conversion unit 17 which performs a conversion process for a sound signal. One configuration using the two sound receiving units, i.e., the main sound receiving unit 11 and the sub-sound receiving unit 12, is illustrated here. However, three or more sound receiving units may also be used. A conversion process by the sound conversion unit 17 is a process of converting sound signals which are analog signals received by the main sound receiving unit 11 and the sub-sound receiving unit 12 into digital signals. The sound receiving device 1 includes an operation unit 18 which accepts an operation by a key input of alphabetic characters and various instructions and a display unit 19 such as a liquid crystal display which displays various pieces of information.

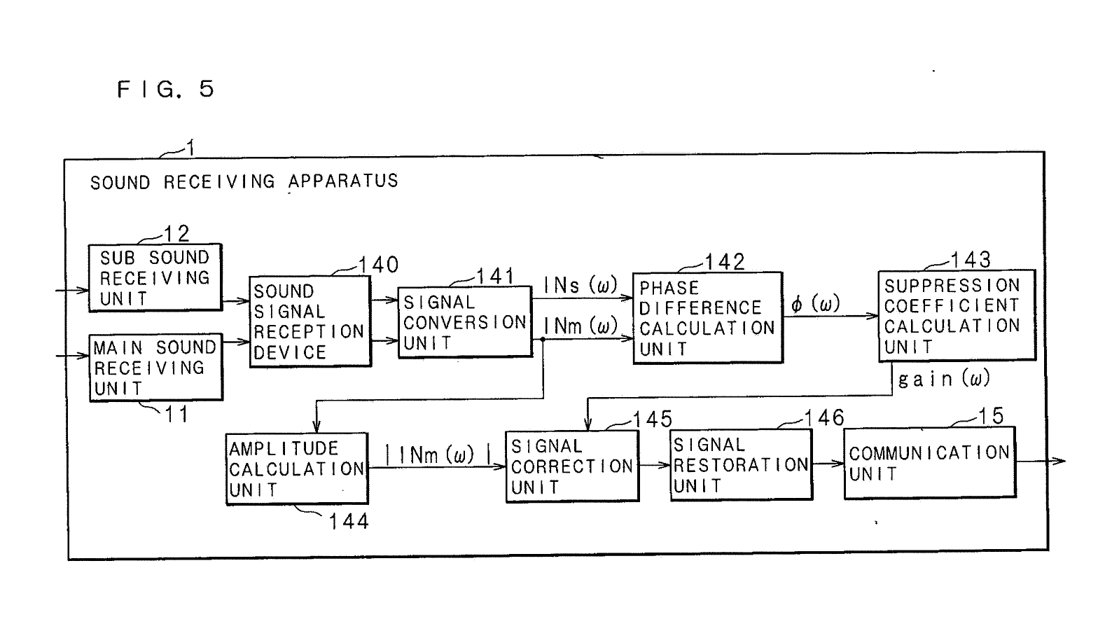

FIG. 5 is a functional block diagram illustrating an example of a functional configuration of the sound receiving device 1 according to Embodiment 1. The sound receiving device 1 according to the present embodiment includes the main sound receiving unit 11 and the sub-sound receiving unit 12, a sound signal receiving unit 140, a signal conversion unit 141, a phase difference calculation unit 142, a suppression coefficient calculation unit 143, an amplitude calculation unit 144, a signal correction unit 145, a signal restoration unit 146, and the communication unit 15. The sound signal receiving unit 140, the signal conversion unit 141, the phase difference calculation unit 142, the suppression coefficient calculation unit 143, the amplitude calculation unit 144, the signal correction unit 145, and the signal restoration unit 146 indicate functions serving as software realized by causing the control unit 13 to execute the various computer programs recorded in the recording unit 14. However, the means may also be realized by using dedicated hardware such as various processing chips.

The main sound receiving unit 11 and the sub-sound receiving unit 12 accept sound signals as analog signals and performs an anti-aliasing filter process by an LPF (Low Pass Filter) to prevent an aliasing error (aliasing) from occurring when the analog signal is converted into a digital signal by the sound conversion unit 17, before converting the analog signals into digital signals and giving the digital signals to the sound signal receiving unit 140. The sound signal receiving unit 140 accepts the sound signals converted into digital signals and gives the sound signals to the signal conversion unit 141. The signal conversion unit 141 generates frames each having a given time length, which serves as a process unit, from the accepted sound signals, and converts the frames into complex spectrums which are signals on a frequency axis by an FFT (Fast Fourier Transformation) process, respectively. In the following explanation, an angular frequency ω is used, a complex spectrum obtained by converting a sound received by the main sound receiving unit 11 is represented as INm(ω), and a complex spectrum obtained by converting a sound received by the sub-sound receiving unit 12 is represented as INs(ω).

The phase difference calculation unit 142 calculates a phase difference between the complex spectrum INm(ω) of a sound received by the main sound receiving unit 11 and the complex spectrum INs(ω) of a sound received by the sub-sound receiving unit 12 as a phase difference spectrum φ(ω) for every angular frequency. The phase difference spectrum φ(ω) is a time difference representing a delay time of the sound receiving time of the main sound receiving unit 11 with respect to the sound receiving time of the sub-sound receiving unit 12 for every angular frequency and uses a radian as a unit.

The suppression coefficient calculation unit 143 calculates a suppression coefficient gain(ω) for every frequency based on the phase difference spectrum φ(ω) calculated by the phase difference calculation unit 142.

The amplitude calculation unit 144 calculates a value of an amplitude spectrum |INm(ω)| of the complex spectrum INm(ω) obtained by converting the sound received by the main sound receiving unit 11.

The signal correction unit 145 multiplies the amplitude spectrum |INm(ω)| calculated by the amplitude calculation unit 144 by the suppression coefficient gain(ω) calculated by the suppression coefficient calculation unit 143.

The signal restoration unit 146 performs IFFT (Inverse Fourier Transform) process by using the amplitude spectrum |INm(ω)| multiplied by the suppression coefficient gain(ω) by the signal correction unit 145 and phase information of the complex spectrum INm(ω) to return the signal to the sound signal on a time axis and re-synthesizes a sound signal in a frame unit to obtain a digital time signal sequence. After encoding required for communication is performed, the signal is transmitted from the antenna of the communication unit 15.

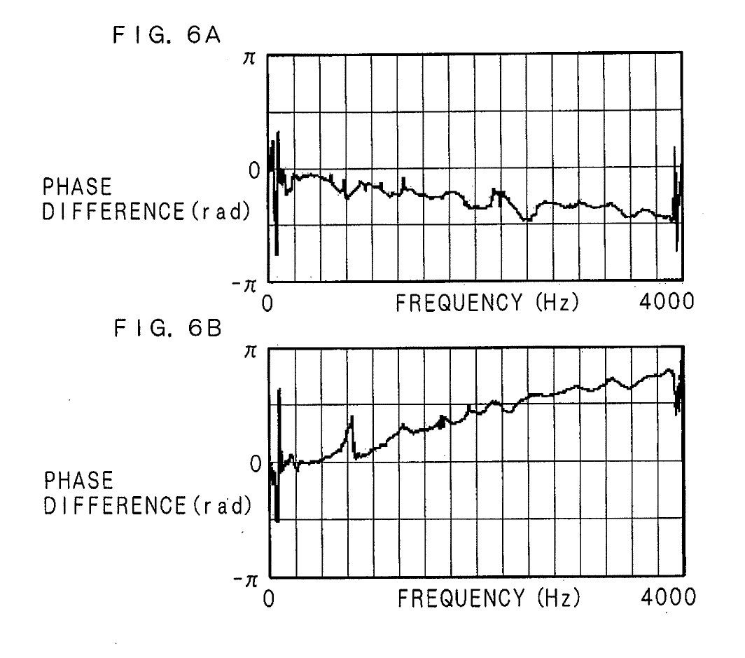

A directivity of the sound receiving device 1 according to Embodiment 1 will be described below. FIG. 6 is a graph illustrating an example of the phase difference spectrum φ(ω) of the sound receiving device 1 according to Embodiment 1. FIG. 6 illustrates, with respect to the phase difference spectrum φ(ω) calculated by the phase difference calculation unit 142, a relation between a frequency (Hz) represented on an ordinate and a phase difference (radian) represented on an abscissa. The phase difference spectrum φ(ω) indicates time differences of sounds received by the main sound receiving unit 11 and the sub-sound receiving unit 12 in units of frequencies. Under ideal circumstances, the phase difference spectrum φ(ω) forms a straight line passing through the origin of the graph illustrated in FIG. 6, and an inclination of the straight line changes depending on reaching time differences, i.e., arriving directions of sounds.

FIG. 6A illustrates a phase difference spectrum φ(ω) of a signal arriving from a direction of the front face (sound receiving face) of the housing 10 of the sound receiving device 1, and FIG. 6B illustrates a phase difference spectrum (φ)(ω) of a sound arriving from a direction of the back face of the housing 10. As illustrated in FIGS. 1 to 3, when the main sound receiving unit 11 is arranged on the front face of the housing 10 of the sound receiving device 1, and when the sub-sound receiving unit 12 is arranged on the bottom face of the housing 10, a phase difference spectrum φ(ω) of a sound arriving from a direction of the front face, in particular, from a diagonally upper side of the front face exhibits a negative inclination. A phase difference spectrum φ(ω) of a sound arriving from a direction other than the direction of the front face, for example, a direction of a back face exhibits a positive inclination. An inclination of the phase difference spectrum φ(ω) of a sound arriving from the diagonally upper side of the front face of the housing 10 is maximum in the negative direction, and, as illustrated in FIG. 6B, the inclination of the phase difference spectrum φ(ω) of the sound arriving from the direction of the back face of the housing 10 increases in the positive direction.

In the suppression coefficient calculation unit 143, with respect to a sound signal having a frequency at which the value of the phase difference spectrum φ(ω) calculated by the phase difference calculation unit 142 is in the positive direction, a suppression coefficient gain(ω) which suppresses the amplitude spectrum |INm(ω)| is calculated, so that a sound arriving from a direction other than the direction of the front face may be suppressed.

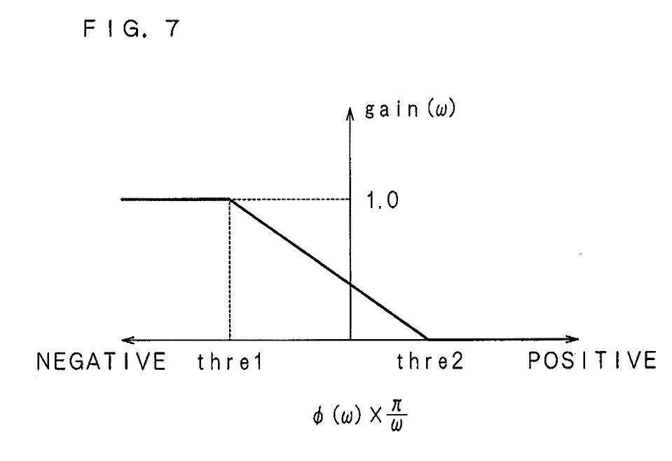

FIG. 7 is a graph illustrating an example of the suppression coefficient gain(ω) of the sound receiving device 1 according to Embodiment 1. In FIG. 7, a value φ(ω)×π/ω obtained by normalizing the phase difference spectrum φ(ω) by the angular frequency ω is plotted on the abscissa, and a suppression coefficient gain(ω) is plotted on the ordinate, to represent a relation between the value and the suppression coefficient. A numerical formula representing the graph illustrated in FIG. 7 is the following formula 1.

$$\begin{matrix} [ Numerical Formula 1 ] & \\ gain = \{ \begin{matrix}1.0 , & φ ( ω ) \times < thre 1 \\ 1 - \frac{φ ( ω ) \times \frac{π}{ω} - thre 1}{thre 2 - thre 1} , & thre 1 ≦ φ ( ω ) \times \frac{π}{ω} ≦ thre 2 \\ 0.0 , & φ ( ω ) \times \frac{π}{ω} > thre 2\end{matrix} & ( Formula 1 )\end{matrix}$$

As represented in FIG. 7 and Formula 1, with respect to the sound arriving from the direction of the front face of the housing 10, a first threshold thre1 which is an upper limit of an inclination φ(ω)×π/ω at which suppression is not carried out at all is set such that the suppression coefficient gain(ω) is 1. With respect to the sound arriving from the direction of the back face of the housing 10, a second threshold thre2 which is a lower limit of an inclination φ(ω)×π/ω at which suppression is completely carried out is set such that the suppression coefficient gain(ω) is 0. As the suppression coefficients gain(ω) whose the normalized phase difference spectrum φ(ω)×π/ω is in between the first threshold and the second threshold, values obtained by directly interpolating the first threshold thre1 and the second threshold thre2 with respect to the suppression coefficients gain(ω).

By using the suppression coefficients gain(ω) set as described above, when the value of the normalized phase difference spectrum φ(ω)×π/ω is small, i.e., when the sub-sound receiving unit 12 receives a sound later than the reception of sound by the main sound receiving unit 11, the sound is a sound arriving from a direction of the front face of the housing 10. For this reason, it is determined that suppression is unnecessary, and a sound signal is not suppressed. When the value of the normalized phase difference spectrum φ(ω)×π/ω is large, i.e., when the main sound receiving unit 11 receives a sound later than the reception of sound by the sub-sound receiving unit 12, the sound is a sound arriving from a direction of the back face of the housing 10. For this reason, it is determined that suppression is necessary, and the sound signal is suppressed. In this manner, the directivity is set in the direction of the front face of the housing 10, and a sound arriving from a direction other than the direction of the front face may be suppressed.

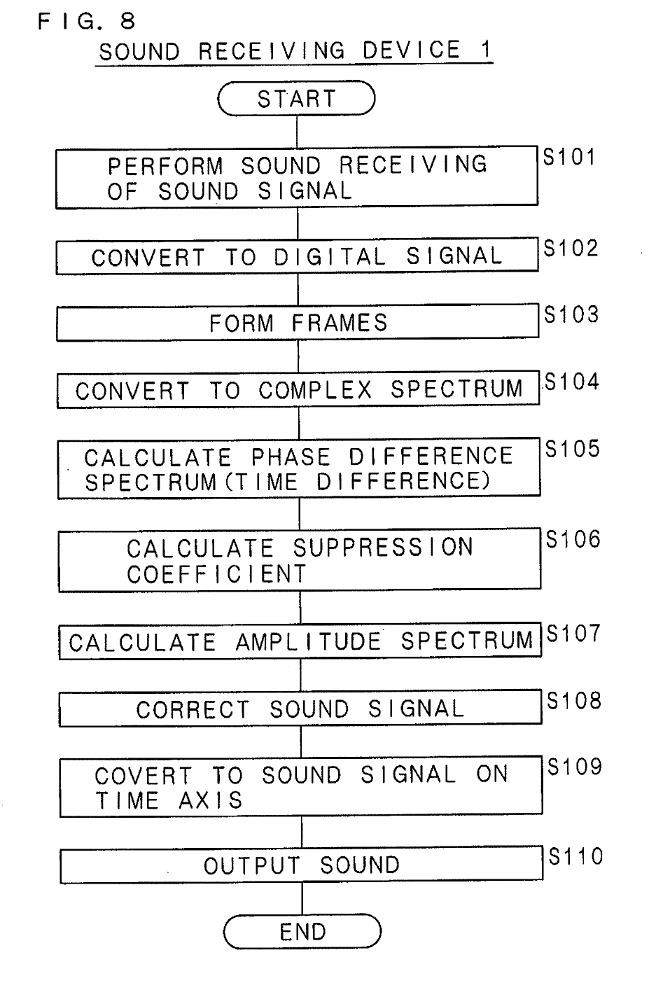

Processes of the sound receiving device 1 according to Embodiment 1 will be described below. FIG. 8 is a flow chart illustrating an example of the processes of the sound receiving device 1 according to Embodiment 1. The sound receiving device 1 receives sound signals at the main sound receiving unit 11 and the sub-sound receiving unit 12 under the control of the control unit 13 which executes a computer program (S101).

The sound receiving device 1 filters sound signals received as analog signals through an anti-aliasing filter by a process of the sound conversion unit 17 based on the control of the control unit 13, samples the sound signals at a sampling frequency of 8000 Hz or the like, and converts the signals into digital signals (S102).

The sound receiving device 1 generates a frame having a given time length from the sound signals converted into the digital signals by the process of the signal conversion unit 141 based on the control of the control unit 13 (S103). In step S103, the sound signals are framed in units each having a given time length of about 32 ms. The processes are executed such that each of the frames is shifted by a given time length of 20 ms or the like while overlapping the previous frame. A frame process which is general in the field of speech recognition such as a windowing using a window function of a hamming window, a hanning window or the like, or filtering performed by a high emphasis filter is performed to the frames. The following processes are performed to the frames generated in this manner.

The sound receiving device 1 performs an FFT process to a sound signal in frame units by the process of the signal conversion unit 141 based on the control of the control unit 13 to convert the sound signal into a complex spectrum which is a signal on a frequency axis.

In the sound receiving device 1, the phase difference calculation unit 142 based on the control of the control unit 13 calculates a phase difference between a complex spectrum of a sound received by the sub-sound receiving unit 12 and a complex spectrum of a sound received by the main sound receiving unit 11 as a phase difference spectrum for every frequency (S105), and the suppression coefficient calculation unit 143 calculates a suppression coefficient for every frequency based on the phase difference spectrum calculated by the phase difference calculation unit 142 (S106). In step S105, with respect to the arriving sounds, a phase difference spectrum is calculated as a time difference between the sound receiving time of the sub-sound receiving unit 11 and the sound receiving time of the main sound receiving unit 12.

The sound receiving device 1 calculates an amplitude spectrum of a complex spectrum obtained by converting the sound received by the main sound receiving unit 11 by the process of the amplitude calculation unit 144 based on the control of the control unit 13 (S107), and multiplies the amplitude spectrum by a suppression coefficient by the process of the signal correction unit 145 to correct the sound signal (S108). The signal restoration unit 146 performs an IFFT process to the signal to perform conversion for restoring the signal into a sound signal on a time axis (S109). The sound signals in frame units are synthesized to be output to the communication unit 15 (S110), and the signal is transmitted from the communication unit 15. The sound receiving device 1 continuously executes the above series of processes until the reception of sounds by the main sound receiving unit 11 and the sub-sound receiving unit 12 is ended.

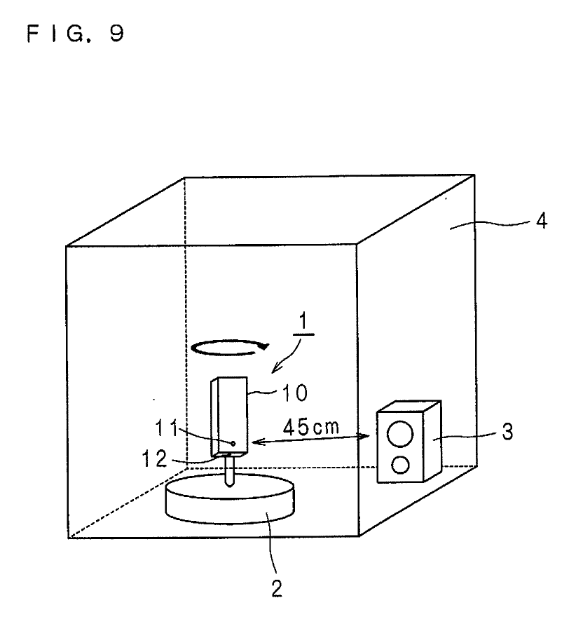

A measurement result of a directional characteristic of the sound receiving device 1 according to Embodiment 1 will be described below. FIG. 9 is an explanatory diagram illustrating an outline of a measurement environment of a directional characteristic of the sound receiving device 1 according to Embodiment 1. In measurement illustrated in FIG. 9, the sound receiving device 1 in which the main sound receiving unit 11 and the sub-sound receiving unit 12 are arranged in a model of a mobile phone is fixed to a turntable 2 which rotates in the horizontal direction. The sound receiving device 1 is stored in an anechoic box 4 together with a voice reproducing loudspeaker 3 arranged at a position distanced by 45 cm. The turntable 2 is horizontally rotated in units of 30°. Every 30° rotation of the turntable 2, an operation which outputs speech data of short sentence having a length of about 2 seconds and uttered by a male speaker from the voice reproducing loudspeaker 3 was repeated until the turntable 2 rotates by 360°, to measure the directional characteristic of the sound receiving device 1. The first threshold thre1 was set to −1.0, and the second threshold thre2 was set to 0.05.

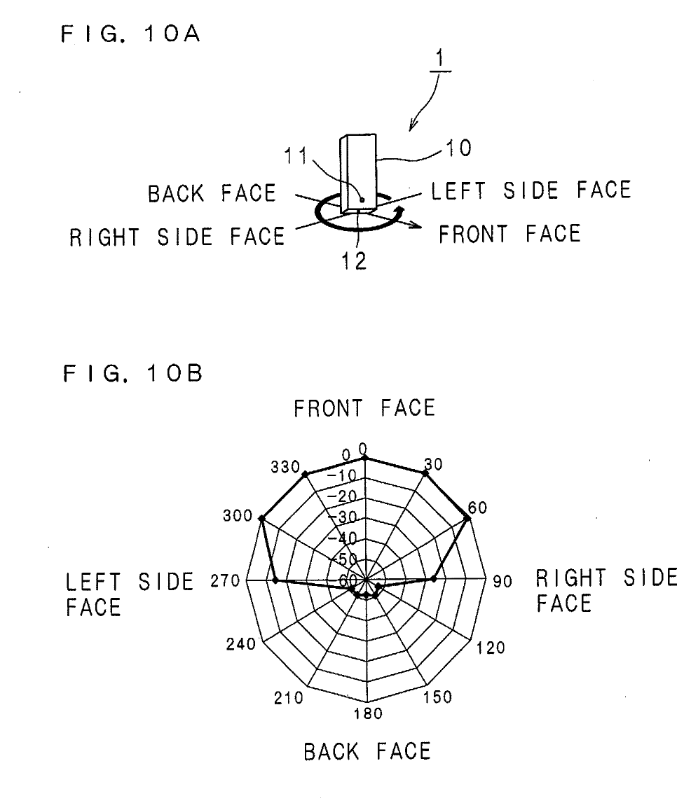

FIGS. 10A and 10B are measurement results of a horizontal directional characteristic of the sound receiving device 1 according to Embodiment 1. In FIG. 10A, a rotating direction of the housing 10 of the sound receiving device 1 related to measurement of the directional characteristic is indicated by an arrow. FIG. 10B is a radar chart illustrating a measurement result of a directional characteristic, indicating a signal intensity (dB) obtained after a sound received by the sound receiving device 1 is suppressed for every arriving direction of a sound. A condition in which a sound arrives from a direction of the front face which is a sound receiving face of the housing 10 of the sound receiving device 1 is set to 0°, a condition in which the sound arrives from a direction of a right side face is set to 90°, a condition in which the sound arrives from a direction of a back face is set to 180°, and a condition in which the sound arrives from a direction of a left side face is set to 270°. As illustrated in FIGS. 10A and 10B, the sound receiving device 1 according to the present embodiment suppresses sounds arriving in the range of 90 to 270°, i.e., from the direction of the side face to the direction of the back face of the housing 10, by 50 dB or more. When the sound receiving device 1 has as its object to suppress sounds arriving from directions other than a direction of a speaker, it is apparent that the sound receiving device 1 exhibits a preferable directional characteristic.

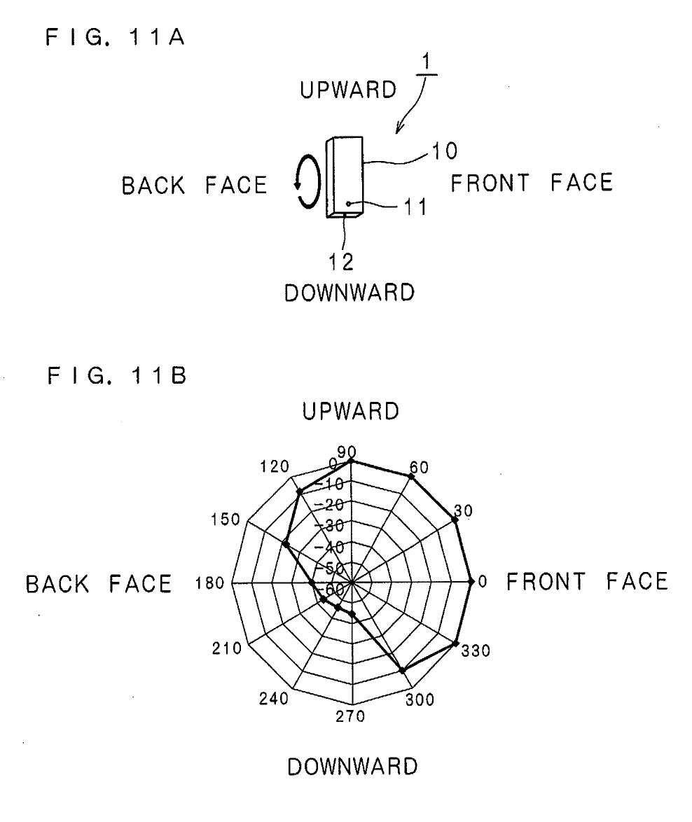

FIGS. 11A and 11B illustrate measurement results of a vertical directional characteristic of the sound receiving device 1 according to Embodiment 1. In FIG. 11A, a rotating direction of the housing 10 of the sound receiving device 1 related to measurement of the directional characteristic is indicated by an arrow. FIG. 11B is a radar chart illustrating a measurement result of a directional characteristic, indicating a signal intensity (dB) obtained after a sound received by the sound receiving device 1 is suppressed for every arriving direction of a sound. In measurement of a vertical directional characteristic, the housing 10 of the sound receiving device 1 was rotated in units of 30° by using a straight line for connecting centers of gravity of both side faces as a rotating axis. Every 30° rotation of the housing 10, an operation which outputs speech data of short sentence having a length of about 2 seconds and uttered by a male speaker from the voice reproducing loudspeaker 3 was repeated until the housing 10 rotates by 360°, to measure the directional characteristic of the sound receiving device 1. A condition in which a sound arrives from a direction of the front face which is a sound receiving face of the housing 10 of the sound receiving device 1 is set to 0°, a condition in which the sound arrives from a direction of an upper face is set to 90°, a condition in which the sound arrives from a direction of a back face is set to 180°, and a condition in which the sound arrives from a direction of a bottom face is set to 270°. In the sound receiving device 1 according to the present embodiment, as illustrated in FIGS. 11A and 11B, a measurement result in which the sound receiving device 1 has a directivity from the front face to the upper face of the housing 10, i.e., in a direction of the mouth of a speaker is obtained.

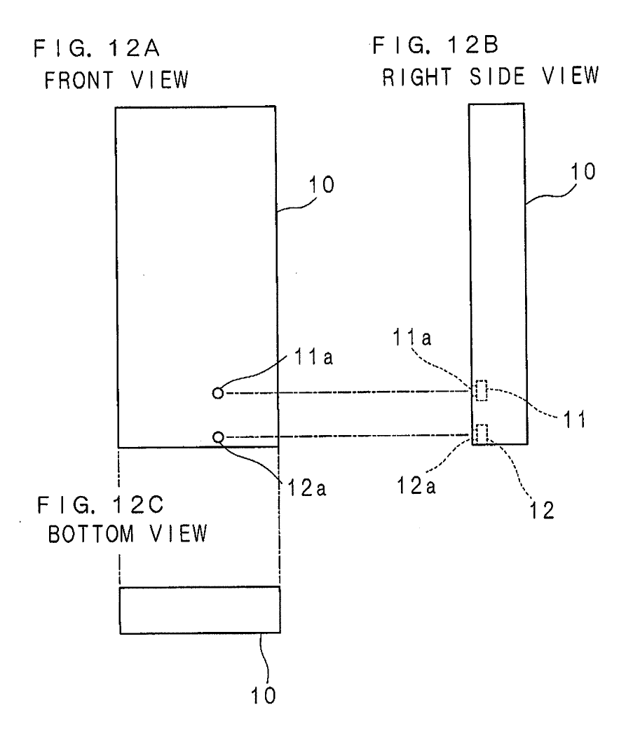

Embodiment 1 described above gives an example in which the sub-sound receiving unit 12 is arranged on a bottom face of the sound receiving device 1. However, if a target directional characteristic is obtained, the sub-sound receiving unit 12 may also be arranged on a face other than the bottom face. FIGS. 12A to 12C represent a trihedral diagram illustrating an example of an appearance of the sound receiving device 1 according to Embodiment 1. FIG. 12A is a front view, FIG. 12B is a side view, and FIG. 12C is a bottom view. In the sound receiving device 1 illustrated in FIG. 12, the sub-sound receiving unit 12 is arranged on an edge of the front face which is the sound receiving face of the housing 10. More specifically, the sub-sound receiving unit 12 is arranged at a position having a minimum distance to the edge of the sound receiving face, the minimum distance being shorter than that of the main sound receiving unit 11. In this manner, since the sound receiving device 1 in which the main sound receiving unit 11 and the sub-sound receiving unit 12 are arranged generates a reaching time difference to a sound from a direction of the back face, the sound receiving device 1 may suppress the sound arriving from the direction of the back face. This arrangement, however, requires caution because suppression in the direction at an angle of 90° and the direction at an angle of 270° cannot be carried out due to the time difference of the sound arriving from the front face being the same as the time difference of a sound arriving from a side. The sub-sound receiving unit 12 may also be arranged on the back face, to generate a reaching time difference. However, when the sound receiving device 1 is a mobile phone, this arrangement position is not preferable because the back face may be covered with a hand of a speaker.

Embodiment 1 described above illustrates the configuration which is applied to the sound receiving device having a directivity by suppressing a sound from the back of the housing. The present embodiment is not limited to the configuration. A sound from the front of the housing may be enhanced, and not only suppression but also enhancement may be performed depending on directions, to realize various directional characteristics.

### Embodiment 2

Embodiment 2 is one configuration in which the directional characteristic of the sound receiving device described in Embodiment 1 is simulated without performing actual measurement. The configuration may be applied to check of the directional characteristic and also determination of an arrangement position of a sound receiving unit. Embodiment 2, as illustrated in FIG. 1 in Embodiment 1, describes the configuration which is applied to a sound receiving device including a rectangular parallelepiped housing, having a main sound receiving unit arranged on a front face of the housing, which serves as a sound receiving face, and having a sub-sound receiving unit arranged on a bottom face. In the following explanation, the same reference numerals as in Embodiment 1 denote the same constituent elements as in Embodiment 1, and a description thereof will not be repeated.

In Embodiment 2, a virtual plane which is in contact with one side or one face of the housing 10 and which has infinite spreads is assumed. It is assumed that a sound arriving from a sound source reaches the entire area of the assumed virtual plane uniformly, i.e., at the same time. Based on a relation between a path length representing a distance from the assumed virtual plane to the main sound receiving unit 11 and a path length representing a distance from the assumed virtual plane to the sub-sound receiving unit 12, a phase difference is calculated. When a sound from the virtual plane cannot directly reaches the main sound receiving unit 11 or the sub-sound receiving unit 12, it is assumed that a sound signal reaches the housing 10 and is diffracted along the housing 10, and then reaches the main sound receiving unit 11 or the sub-sound receiving unit 12 through a plurality of paths along the housing 10.

In Embodiment 2, a virtual plane which is in contact with a front face, a back face, a right side face and a left side face of the housing 10 and a virtual plane which is in contact with one side constituted by two planes of the front face, the back face, the right side face and the left side face are assumed. Sounds arriving from the respective virtual planes are simulated to have a horizontal directional characteristic. Furthermore, a virtual plane which is in contact with the front face, the back face, an upper face, and a bottom face of the housing 10 and a virtual plane which is in contact with one side constituted by two planes of the front face, the back face, the upper face, and the bottom face of the housing 10 are assumed. Sounds arriving from the respective virtual planes are simulated to have a vertical directional characteristic.

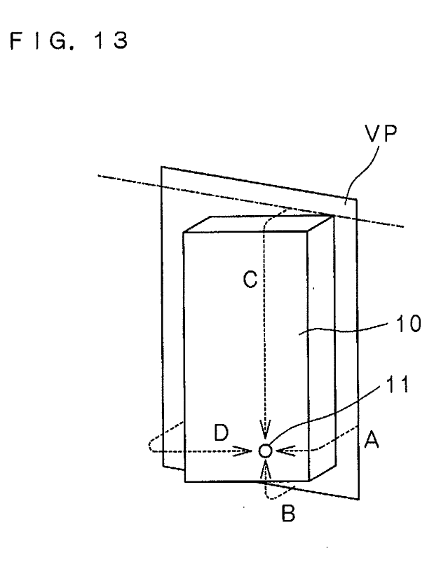

First, the horizontal directional characteristic is simulated. FIG. 13 is a perspective view illustrating an example of a reaching path of a sound signal assumed to the sound receiving device 1 according to Embodiment 2 of. In FIG. 13, a virtual plane VP which is in contact with one side constituted by the back face and the left side face of the housing 10 is assumed, and a path of a sound arriving from a back face side at the main sound receiving unit 11 arranged on the housing 10 of the sound receiving device 1 is illustrated. As illustrated in FIG. 13, a sound arriving from the back face side at the housing 10 reaches the main sound receiving unit 11 through four reaching paths which are the shortest paths passing through the upper face, the bottom face, the right side face and the left side face of the housing 10, respectively. In FIG. 13, a path A is a path reaching the main sound receiving unit 11 from the left side face, a path B is a path reaching the main sound receiving unit 11 from the bottom face, a path C is a path reaching to the main sound receiving unit 11 from the upper face, and a path D is a path reaching the main sound receiving unit 11 from the right side face along the housing 10.

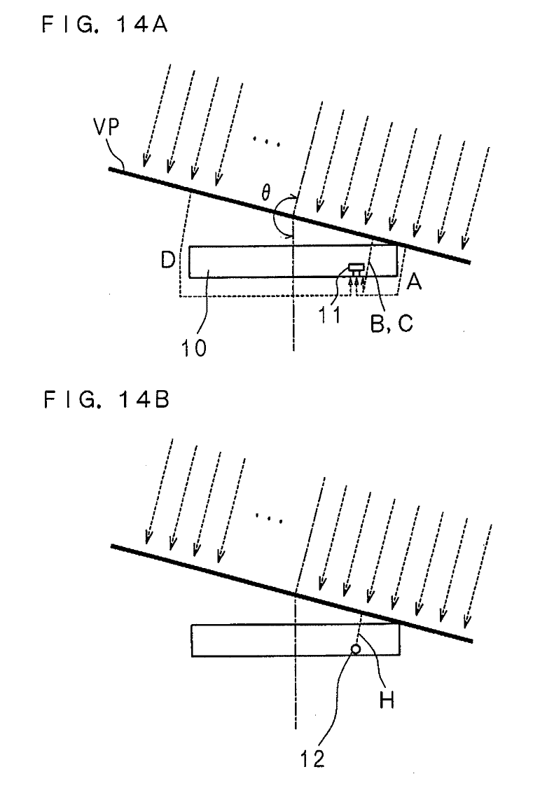

FIGS. 14A and 14B are upper views illustrating examples of reaching paths of sound signals assumed to the sound receiving device 1 according to Embodiment 2. In FIG. 14A, a virtual plane VP which is in contact with one side constituted by the back face and the left side face of the housing 10 is assumed, and a sound reaching path to the main sound receiving unit 11 is illustrated. An angle formed by a vertical line to the front face of the housing 10 and a vertical line to the virtual plane VP is indicated as an incident angle θ of a sound with respect to the housing 10. As illustrated in FIG. 14A, a sound uniformly reaching the virtual plane VP reaches the main sound receiving unit 11 through the path A, the path B, the path C and the path D.

FIG. 14B illustrates a reaching path to the sub-sound receiving unit 12. Since the sub-sound receiving unit 12 is arranged on the bottom face of the housing 10, the sub-sound receiving unit 12 has a reaching path through which a sound arriving from a direction of the back face directly reaches from the virtual plane VP. Thus, the sound reaches the sub-sound receiving unit 12 through one reaching path which directly reaches the sub-sound receiving unit 12.

Since sound signals reaching the main sound receiving unit 11 through the plurality of reaching paths reach the main sound receiving unit 11 in phases depending on path lengths, a sound signal is formed by synthesizing the sound signals having different phases. A method of deriving a synthesized sound signal will be described below. From path lengths of the reaching paths, phases at 1000 Hz of the sound signals reaching the main sound receiving unit 11 through the respective reaching paths are calculated based on the following formula 2. Although an example at 1000 Hz is explained here, frequencies which are equal to or lower than Nyquist frequencies such as 500 Hz or 2000 Hz may also be used.

φp=1000·dp·2π/v (Formula 2)

where φp: phase at 1000 Hz of a sound signal reaching the main sound receiving unit 11 through a path p (p=A, B, C and D)
dp: path length of path p
v: sound velocity (typically 340 m/s)

From phases φA, φB, φC and φD of the paths A, B, C and D calculated by Formula 2, a sine wave representing a synthesized sound signal is calculated based on the following Formula 3, and a phase cpm of the calculated sine wave is set as a phase of the sound signal reaching the main sound receiving unit 11.

α·sin(x+φm)={ sin(x+φA)}/dA+{ sin(x+φB)}/dB+{ sin(x+φC)}/dC+{ sin(x+φD)}/dD} (Formula 3)

where, α·sin(x+φm): sine wave representing a synthesized sound signal

α: amplitude of a synthesized sound signal (constant)

x: 1000/(f·2π·i)

f: sampling frequency (8000 Hz)

i: identifier of a sample

φm: phase of a sound signal (synthesized sound signal) received by the main sound receiving unit 11

sin(x+φA): sine wave representing a sound signal reaching through the path A

sin(x+φB): sine wave representing a sound signal reaching through the path B

sin(x+φC): sine wave representing a sound signal reaching through the path C

sin(x+φD): sine wave representing a sound signal reaching through the path D

As illustrated in Formula 3, the sine wave representing the synthesized sound signal is derived by multiplying the respective sound signals reaching the main sound receiving unit 11 through the paths A, B, C and D by reciprocals of path lengths as weight coefficients and by summing them up. Since the phase φm of the synthesized sound signal derived by Formula 3 is a phase at 1000 Hz, it is multiplied by 4 to be converted into a phase at 4000 Hz which is a Nyquist frequency.

When the sound signal directly reaches the main sound receiving unit 11, a phase of the sound signal received by the main sound receiving unit 11 at 4000 Hz is calculated from the path length by using the following Formula 4.

φm=(4000·d·2π)/v (Formula 4)

where, d: path length from the virtual plane VP

When a sound arriving from a horizontal direction is assumed with respect to the sound receiving device 1, a sound signal always directly arrives at the sub-sound receiving unit 12. A phase of the sound signal received by the sub-sound receiving unit 12 at 4000 Hz is calculated from the path length by using the following Formula 5.

φs=(4000·d·2π)/v (Formula 5)

Path lengths from the virtual plane VP to the main sound receiving unit 11 and the sub-sound receiving unit 12 are calculated for each of quadrants obtained by dividing the incident angle θ in units of π/2. In the following explanation, reference numerals representing sizes such as various distances related to the housing 10 of the sound receiving device 1 correspond to the reference numerals represented in FIGS. 2 and 3 according to Embodiment 1.

When 0≦θ<π/2

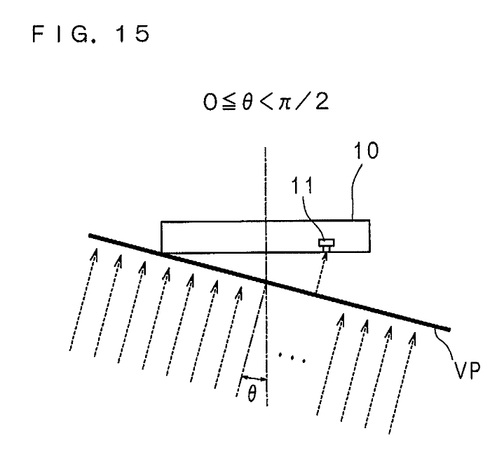

FIG. 15 is an upper view conceptually illustrating a positional relation in 0≦θ<π/2 between the virtual plane VP and the sound receiving device 1 according to Embodiment 2. When the sound receiving device 1 and the virtual plane VP have a relation illustrated in FIG. 15, a path length from the virtual plane VP to the main sound receiving unit 11 is expressed by the following Formula 6.

[Numerical Formula 2]

W₁ sin θ+M₁ (Formula 6)

A path length from the virtual plane VP to the sub-sound receiving unit 12 is expressed by the following Formula 7. The path length from the virtual plane VP to the sub-sound receiving unit 12 is expressed by two different formulas depending on the incident angle θ as expressed in Formula 7.

$$\begin{matrix}[ Numerical Formula 3 ] & \\ \begin{matrix}\frac{N}{cos ( θ )} + ( {W}_{2} - N tan θ ) sin θ + {M}_{2} , \\ ( 0 ≦ θ < arctan ( \frac{{W}_{2}}{N} ) ) \\ \frac{{W}_{2}}{sin ( θ )} + ( N - \frac{{W}_{2}}{tan ( θ )} ) cos θ + {M}_{2} , \\ ( arctan ( \frac{{W}_{2}}{N} ) ≦ θ < \frac{π}{2} )\end{matrix} & ( Formula 7 )\end{matrix}$$

When π/2≦θ<π

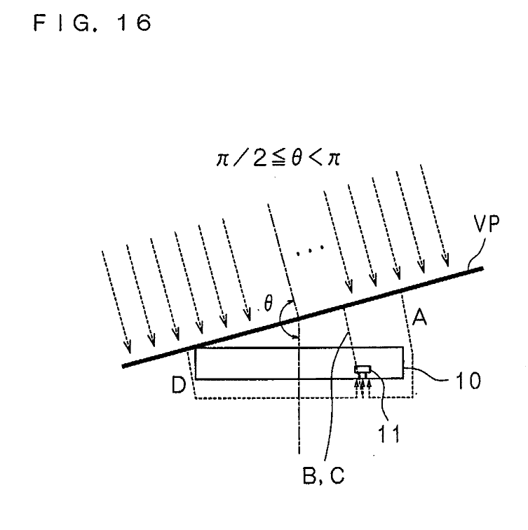

FIG. 16 is an upper view conceptually illustrating a positional relation in π/2≦θ<π between the virtual plane VP and the sound receiving device 1 according to Embodiment 2. When the sound receiving device 1 and the virtual plane VP have the relation illustrated in FIG. 16, a path length of the path A from the virtual plane VP to the main sound receiving unit 11 is expressed by the following Formula 8.

$$\begin{matrix}[ Numerical Formula 4 ] & \\ W cos ( θ - \frac{π}{2} ) + D ( W - {W}_{1} ) + {M}_{1} & ( Formula 8 )\end{matrix}$$

A path length of the path B from the virtual plane VP to the main sound receiving unit 11 is expressed by the following Formula 9. The distance from the virtual plane VP to the main sound receiving unit 11 is expressed by two different formulas depending on the incident angle θ as expressed by Formula 9.

$$\begin{matrix} [ Numerical Formula 5 ] & \\ \begin{matrix} \frac{{W}_{1}}{cos ( θ - \frac{π}{2} )} + ( D - {W}_{1} tan ( θ - \frac{π}{2} ) ) sin ( θ - \frac{π}{2} ) + H + {M}_{1} , \\ ( \frac{π}{2} ≦ θ < arctan ( \frac{D}{{W}_{1}} ) + \frac{π}{2} ) \\ \frac{D}{sin ( θ - \frac{π}{2} )} + ( {W}_{1} - \frac{D}{tan ( θ - \frac{π}{2} )} ) cos ( θ - \frac{π}{2} ) + H + {M}_{1} , \\ ( arctan ( \frac{D}{{W}_{1}} ) + \frac{π}{2} ≦ θ < π )\end{matrix} & ( Formula 9 )\end{matrix}$$

A path length of the path C from the virtual plane VP to the main sound receiving unit 11 is expressed by the following Formula 10. A path length of the path C from the virtual plane VP to the main sound receiving unit 11 is expressed by two different formulas depending on the incident angle θ as expressed by Formula 10.

$$\begin{matrix} [ Numerical Formula 6 ] & \\ \frac{{W}_{1}}{cos ( θ - \frac{π}{2} )} + ( D - {W}_{1} tan ( θ - \frac{π}{2} ) ) sin ( θ - \frac{π}{2} ) + L + {M}_{1} , & ( Formula 10 ) \\ ( \frac{π}{2} ≦ θ < arctan ( \frac{D}{{W}_{1}} ) + \frac{π}{2} ) & \\ \frac{D}{sin ( θ - \frac{π}{2} )} + ( {W}_{1} - \frac{D}{tan ( θ - \frac{π}{2} )} ) cos ( θ - \frac{π}{2} ) + L + {M}_{1} , & \\ ( arctan ( \frac{D}{{W}_{1}} ) + \frac{π}{2} ≦ θ < π ) & \end{matrix}$$

A path length of the path D from the virtual plane VP to the main sound receiving unit 11 is expressed by the following Formula 11.

$$\begin{matrix}[ Numerical Formula 7 ] & \\ D sin ( θ - \frac{π}{2} ) + {W}_{1} + {M}_{1} & ( Formula 11 )\end{matrix}$$

A path length from the virtual plane VP to the sub-sound receiving unit 12 is expressed by the following Formula 12. The path length from the virtual plane VP to the sub-sound receiving unit 12 is expressed by two different formulas depending on the incident angle θ as expressed by Formula 12.

$$\begin{matrix} [ Numerical Formula 8 ] & \\ \frac{{W}_{2}}{cos ( θ - \frac{π}{2} )} + ( D - N - {W}_{2} tan ( θ - \frac{π}{2} ) ) sin ( θ - \frac{π}{2} ) + {M}_{2} , \\ ( \frac{π}{2} ≦ θ < arctan ( \frac{D - N}{{W}_{2}} ) + \frac{π}{2} ) \\ \frac{D - N}{sin ( θ - \frac{π}{2} )} + ( {W}_{2} - \frac{D - N}{tan ( θ - \frac{π}{2} )} ) cos ( θ - \frac{π}{2} ) + {M}_{2} , \\ ( arctan ( \frac{D - N}{{W}_{2}} ) + \frac{π}{2} ≦ θ < π ) & ( Formula 12 )\end{matrix}$$

When π≦θ<3π/2

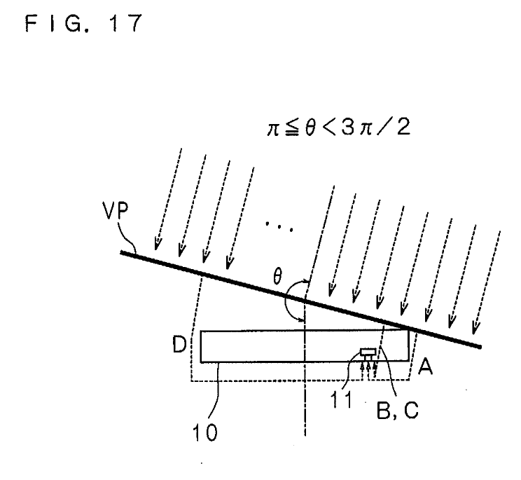

FIG. 17 is an upper view conceptually illustrating a positional relation in π≦θ<3π/2 between the virtual plane VP and the sound receiving device 1 according to Embodiment 2. When the sound receiving device 1 and the virtual plane VP have the relation illustrated in FIG. 17, a path length of the path A from the virtual plane VP to the main sound receiving unit 11 is expressed by the following Formula 13.

$$\begin{matrix}[ Numerical Formula 9 ] & \\ D sin ( \frac{3}{2} π - θ ) + W - {W}_{1} + {M}_{1} & ( Formula 13 )\end{matrix}$$

A path length of the path B from the virtual plane VP to the main sound receiving unit 11 is expressed by the following Formula 14. The distance from the virtual plane VP to the main sound receiving unit 11 is expressed by two different formulas depending on the incident angle θ as expressed by Formula 14.

$$\begin{matrix} [ Numerical Formula 10 ] & \\ \frac{D}{sin ( \frac{3}{2} π - θ )} + ( W - {W}_{1} - \frac{D}{tan ( \frac{3}{2} π - θ )} ) cos ( \frac{3}{2} π - θ ) + H + {M}_{1} , \\ ( π ≦ θ < \frac{3}{2} π - arctan ( \frac{D}{W - {W}_{1}} ) ) \\ \frac{W - {W}_{1}}{cos ( \frac{3}{2} π - θ )} + ( D - ( W - {W}_{1} ) tan ( \frac{3}{2} π - θ ) ) sin ( \frac{3}{2} π - 0 ) + H + {M}_{1} , \\ ( \frac{3}{2} π - arctan ( \frac{D}{W - {W}_{1}} ) ≦ θ < \frac{3}{2} π ) & ( Formula 14 )\end{matrix}$$

A path length of the path C from the virtual plane VP to the main sound receiving unit 11 is expressed by the following Formula 15. A path length of the path C from the virtual plane VP to the main sound receiving unit 11 is expressed by two different formulas depending on the incident angle θ as expressed by Formula 15.

$$\begin{matrix} [ Numerical Formula 11 ] & \\ \frac{D}{sin ( \frac{3}{2} π - θ )} + ( W - {W}_{1} - \frac{D}{tan ( \frac{3}{2} π - θ )} ) cos ( \frac{3}{2} π - θ ) + L + {M}_{1} , \\ ( π ≦ θ < \frac{3}{2} π - arctan ( \frac{D}{W - {W}_{1}} ) ) \\ \frac{W - {W}_{1}}{cos ( \frac{3}{2} π - θ )} + ( D - ( W - {W}_{1} ) tan ( \frac{3}{2} π - θ ) ) sin ( \frac{3}{2} π - 0 ) + L + {M}_{1} , \\ ( \frac{3}{2} π - arctan ( \frac{D}{W - {W}_{1}} ) ≦ θ < \frac{3}{2} π ) & ( Formula 15 )\end{matrix}$$

A path length of the path D from the virtual plane VP to the main sound receiving unit 11 is expressed by the following Formula 16.

$$\begin{matrix}[ Numerical Formula 12 ] & \\ W cos ( \frac{3}{2} π - θ ) + D + {W}_{1} + {M}_{1} & ( Formula 16 )\end{matrix}$$

A path length from the virtual plane VP to the sub-sound receiving unit 12 is expressed by the following Formula 17. The path length from the virtual plane VP to the sub-sound receiving unit 12 is expressed by two different formulas depending on the incident angle θ as expressed by Formula 17.

$$\begin{matrix} [ Numerical Formula 13 ] & \\ \frac{D - N}{sin ( \frac{3}{2} π - θ )} + ( W - {W}_{2} - \frac{D - N}{tan ( \frac{3}{2} π - θ )} ) cos ( \frac{3}{2} π - θ ) + {M}_{2} , \\ ( π ≦ θ < \frac{3}{2} π - arctan ( \frac{D - N}{W - {W}_{1}} ) ) \\ \frac{W - {W}_{2}}{cos ( \frac{3}{2} π - θ )} + ( D - ( W - {W}_{2} ) tan ( \frac{3}{2} π - θ ) ) sin ( \frac{3}{2} π - 0 ) + {M}_{2} , \\ ( \frac{3}{2} π - arctan ( \frac{D - N}{W - {W}_{2}} ) ≦ θ < \frac{3}{2} π ) & ( Formula 17 )\end{matrix}$$

When 3π/2≦θ<2π

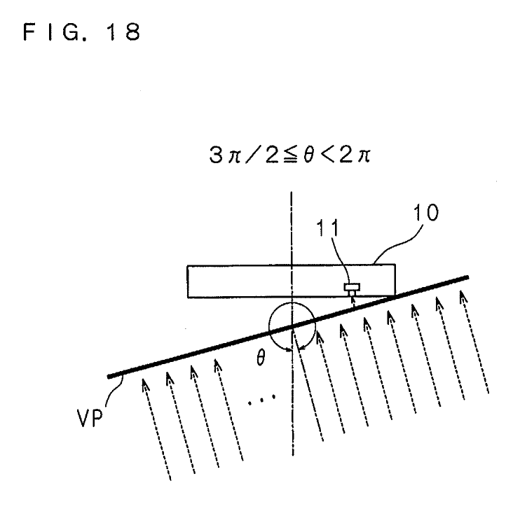

FIG. 18 is an upper view conceptually illustrating a positional relation in 3π/2≦θ<2π between the virtual plane VP and the sound receiving device 1 according to Embodiment 2. When the sound receiving device 1 and the virtual plane VP have the relation illustrated in FIG. 18, a path length from the virtual plane VP to the main sound receiving unit 11 is expressed by the following Formula 18.

[Numerical Formula 14]

(W−W₁)sin(2π−θ)+M₁ (Formula 18)

A path length from the virtual plane VP to the sub-sound receiving unit 12 is expressed by the following Formula 19. A path length from the virtual plane VP to the sub-sound receiving unit 12 is expressed by two different formulas depending on the incident angle θ as expressed by Formula 19.

$$\begin{matrix} [ Numerical Formula 15 ] & \\ \frac{W - {W}_{2}}{sin ( 2 π - θ )} + ( N - \frac{W - {W}_{2}}{tan ( 2 π - θ )} ) cos ( 2 π - θ ) + {M}_{2} , \\ ( \frac{3}{2} π ≦ θ < 2 π - arctan ( \frac{N}{W - {W}_{2}} ) ) \\ \frac{N}{cos ( 2 π - θ )} + ( W - {W}_{2} - N tan ( 2 π - θ ) ) sin ( 2 π - θ ) + {M}_{2} , \\ ( 2 π - arctan ( \frac{N}{W - {W}_{2}} ) ≦ θ < 2 π ) & ( Formula 19 )\end{matrix}$$

Based on the path lengths calculated by the above method, phases of sound received by the main sound receiving unit 11 and the sub-sound receiving unit 12 are calculated respectively, and the phase of the sound received by the main sound receiving unit 11 is subtracted from the phase of the sound received by the sub-sound receiving unit 12 to calculate a phase difference. From the calculated phase difference, processes of calculating a suppression coefficient by using Formula 1 described in Embodiment 1 and converting the suppression coefficient into a value in a decibel unit are executed in the range of 0≦θ<2π, for example, in units of 15°. With these processes, directional characteristics with respect to the arrangement positions of the main sound receiving unit 11 and the sub-sound receiving unit 12 of the sound receiving device 1 may be derived.

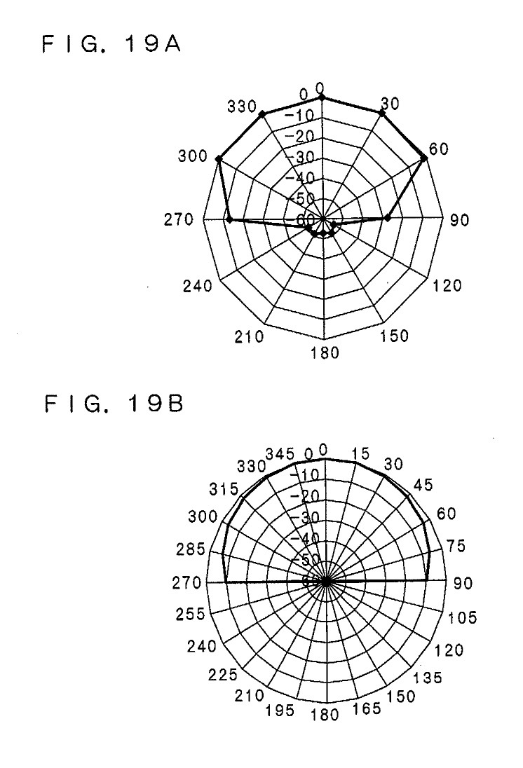

FIGS. 19A and B are radar charts illustrating a horizontal directional characteristic of the sound receiving device 1 according to Embodiment 2. FIGS. 19A and B illustrate a directional characteristic for the housing 10 of the sound receiving device 1 having the sizes indicated in FIGS. 2 and 3 according to Embodiment 1. FIG. 19A illustrates a measurement result obtained by an actual measurement, while FIG. 19B illustrates a simulation result of the directional characteristic derived by the above method. The radar charts indicate signal intensities (dB) obtained after the sound received by the sound receiving device 1 is suppressed for every arriving direction of the sound. FIG. 19A illustrates a signal intensity in an arriving direction for every 30°, and FIG. 19B illustrates a signal intensity in an arriving direction for every 15°. As illustrated in FIGS. 19A and B, it is apparent that both the simulation result and the actual measurement value have strong directional characteristics in a direction of the front face, and a sound from behind is suppressed. It can be read that the simulation result reproduces the directional characteristic of the actual measurement value.

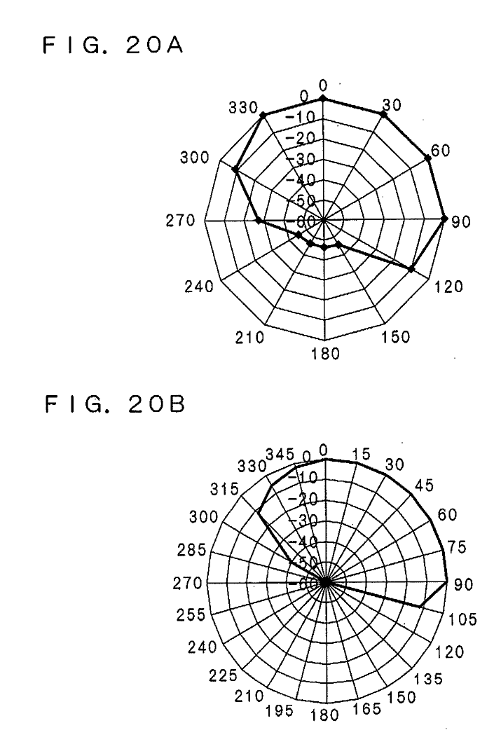

FIGS. 20A and B are radar charts illustrating a horizontal directional characteristic of the sound receiving device 1 according to Embodiment 2. FIGS. 20A and B illustrate, in the sound receiving device 1 having the sizes illustrated in FIGS. 2 and 3 according to Embodiment 1, a directional characteristic of the housing 10 in which a distance W2 from the right end of the sub-sound receiving unit 12 is changed from 2.4 cm to 3.8 cm. FIG. 20A illustrates a measurement result obtained by an actual measurement, and FIG. 20B illustrates a simulation result of the directional characteristic derived by the above method. The radar charts indicate signal intensities (dB) obtained after the sound received by the sound receiving device 1 is suppressed for every arriving direction of the sound. FIG. 20A illustrates a signal intensity in an arriving direction for every 30°, and FIG. 20B illustrates a signal intensity in an arriving direction for every 15°. As illustrated in FIGS. 20A and B, when the sub-sound receiving unit 12 is moved, the center of the directivity shifts to the right in the actual measurement value. This shift may also be reproduced in the simulation result. In this manner, in Embodiment 2, a direction in which a horizontal directivity is made may be checked by the simulation result. Thus, arrangement positions of the main sound receiving unit 11 and the sub-sound receiving unit 12 may be determined while checking the directional characteristic by using the direction.

A vertical directional characteristic is simulated. Also in simulation of the vertical directional characteristic, when there are a plurality of paths reaching the sound receiving unit, a method of calculating phases of sound signals reaching through the reaching paths at 1000 Hz from path lengths of the plurality of paths, respectively, to derive phases of the sound signals reaching the sound receiving unit from the calculated phases is used.

Path lengths from the virtual plane VP to the main sound receiving unit 11 and the sub-sound receiving unit 12 are calculated for each of quadrants obtained by dividing the incident angle θ in units of π/2, the incident angle θ being set as an angle formed by a vertical line to the front face of the housing 10 and a vertical line to the virtual plane VP. In the following explanation, reference numerals representing sizes such as various distances related to the housing 10 of the sound receiving device 1 correspond to the reference numerals presented in FIGS. 2 and 3 according to Embodiment 1, respectively.

When 0≦θ<π/2

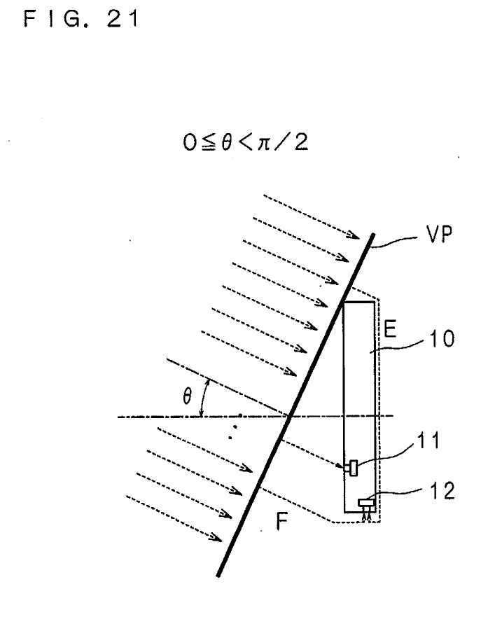

FIG. 21 is a side view conceptually illustrating a positional relation in 0≦θ<π/2 between the virtual plane VP and the sound receiving device 1 according to Embodiment 2. A path E is a path reaching the sub-sound receiving unit 12 on the bottom face from the upper side of the housing 10 through the back face, and a path F is a path reaching the sub-sound receiving unit 12 from the lower side of the housing 10 through the bottom face. When the sound receiving device 1 and the virtual plane VP have the relation illustrated in FIG. 21, a path length from the virtual plane VP to the main sound receiving unit 11 is expressed by the following Formula 20.

[Numerical Formula 16]

H sin(θ)+M₁ (Formula 20)

A path length of the path E from the virtual plane VP to the sub-sound receiving unit 12 is expressed by the following Formula 21.

[Numerical Formula 17]

D cos(θ)+L+H+D−N+M₂ (Formula 21)

A path length of the path F from the virtual plane VP to the sub-sound receiving unit 12 is expressed by the following Formula 22.

[Numerical Formula 18]

(L+H)sin(θ)+N+M₂ (Formula 22)

When π/2≦θ<π

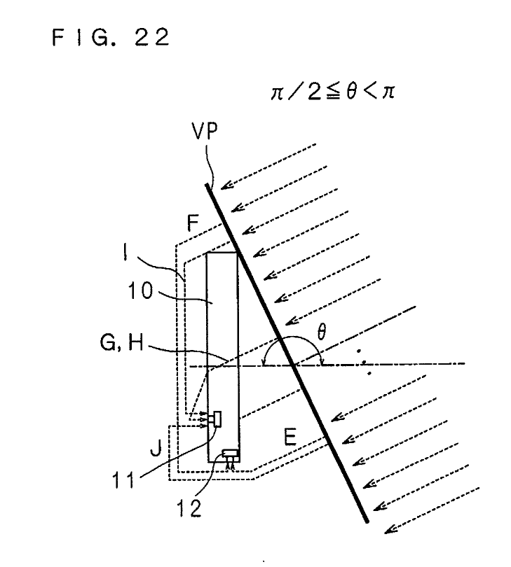

FIG. 22 is a side view conceptually illustrating a positional relation in π/2≦θ<π between the virtual plane VP and the sound receiving device 1 according to Embodiment 2. The path E is a path reaching the sub-sound receiving unit 12 on the bottom face from the lower side of the housing 10, the path F is a path reaching the sub-sound receiving unit 12 on the bottom face from the upper side of the housing 10 through the front face, a path G is a path reaching the main sound receiving unit 11 on the front face from the right side of the housing 10 through a right side face, a path H is a path reaching the main sound receiving unit 11 on the front face from the left side of the housing 10 through the left side face, a path I is a path reaching the main sound receiving unit 11 on the front face from the upper side of the housing 10, and a path J is a path reaching the main sound receiving unit 11 on the front face from the lower side of the housing 10 through the bottom face.

When the sound receiving device 1 and the virtual plane VP have the relation illustrated in FIG. 22, a path length of the path G from the virtual plane VP to the main sound receiving unit 11 is expressed by the following Formula 23. The path length expressed in Formula 23 is limited to a zone given by arc tan(W₁/H)+π/2≦θ<π.

$$\begin{matrix}[ Numerical Formula 19 ] & \\ \frac{{W}_{1} + D}{sin ( θ - \frac{π}{2} )} + ( H - \frac{{W}_{1} + D}{tan ( θ - \frac{π}{2} )} ) cos ( θ - \frac{π}{2} ) + {M}_{1} , \\ ( arctan ( \frac{{W}_{1}}{H} ) + \frac{π}{2} ≦ θ < π ) & ( Formula 23 )\end{matrix}$$

A path length of the path H from the virtual plane VP to the main sound receiving unit 11 is expressed by the following Formula 24. The path length expressed in Formula 24 is limited to a zone given by arc tan {(W−W₁)/H}+π/2≦θ<π.

$$\begin{matrix} [ Numerical Formula 20 ] & \\ \frac{W - {W}_{1} + D}{sin ( θ - \frac{π}{2} )} + ( H - \frac{W - {W}_{1} + D}{tan ( θ - \frac{π}{2} )} ) cos ( θ - \frac{π}{2} ) + {M}_{1} , & ( Formula 24 )\end{matrix}$$

A path length of the path I from the virtual plane VP to the main sound receiving unit 11 is expressed by the following Formula 25.

$$\begin{matrix}[ Numerical Formula 21 ] & \\ D sin ( θ - \frac{π}{2} ) + H + {M}_{1} & ( Formula 25 )\end{matrix}$$

A path length of the path J from the virtual plane VP to the main sound receiving unit 11 is expressed by the following Formula 26.

$$\begin{matrix}[ Numerical Formula 22 ] & \\ ( L + H ) cos ( θ - \frac{π}{2} ) + D + L + {M}_{1} & ( Formula 26 )\end{matrix}$$

A path length of the path E from the virtual plane VP to the sub-sound receiving unit 12 is expressed by the following Formula 27.

$$\begin{matrix}[ Numerical Formula 23 ] & \\ ( L + H ) cos ( θ - \frac{π}{2} ) + D - N + {M}_{2} & ( Formula 27 )\end{matrix}$$

A path length of the path F from the virtual plane VP to the sub-sound receiving unit 12 is expressed by the following Formula 28.

$$\begin{matrix}[ Numerical Formula 24 ] & \\ D sin ( θ - \frac{π}{2} ) + H + N + {M}_{2} & ( Formula 28 )\end{matrix}$$

When π≦θ<3π/2

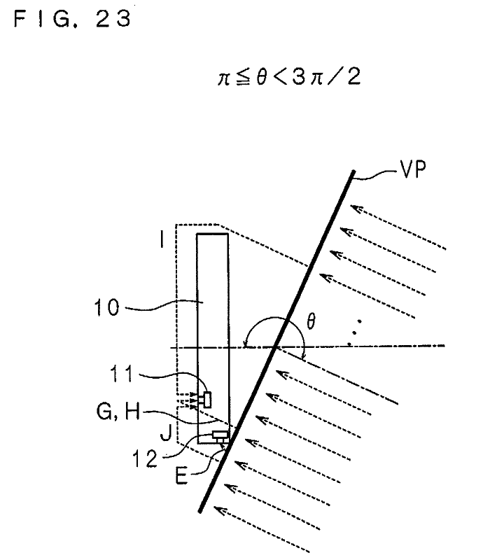

FIG. 23 is a side view conceptually illustrating a positional relation in π≦θ<3π/2 between the virtual plane VP and the sound receiving device 1 according to Embodiment 2. The path E is a path reaching the sub-sound receiving unit 12 on the bottom face from the lower side of the housing 10, the path G is a path reaching the main sound receiving unit 11 on the front face from the right side of the housing 10 through a right side face, the path H is a path reaching the main sound receiving unit 11 on the front face from the left side of the housing 10 through the left side face, the path I is a path reaching the main sound receiving unit 11 on the front face from the upper side of the housing 10, and the path J is a path reaching the main sound receiving unit 11 on the front face from the lower side of the housing 10 through the bottom face.

When the sound receiving device 1 and the virtual plane VP have the relation illustrated in FIG. 23, a path length of the path G from the virtual plane VP to the main sound receiving unit 11 is expressed by the following Formula 29. The path length expressed in Formula 29 is limited to a zone given by π≦θ<arc tan(L/W₁)+π.

$$\begin{matrix} [ Numerical Formula 25 ] & \\ \frac{{W}_{1} + D}{cos ( θ - π )} + ( L - ( {W}_{1} + D ) tan ( θ - π ) ) sin ( θ - π ) + {M}_{1} , \\ ( π ≦ θ < arctan ( \frac{L}{{W}_{1}} ) + π ) & ( Formula 29 )\end{matrix}$$

A path length of the path H from the virtual plane VP to the main sound receiving unit 11 is expressed by the following Formula 30. The path length expressed in Formula 30 is limited to a zone given by π≦θ<arc tan {L/(W−W₁)}+π.

$$\begin{matrix} [ Numerical Formula 26 ] & \\ \frac{W - {W}_{1} + D}{cos ( θ - π )} + ( L - ( W - {W}_{1} + D ) tan ( θ - π ) ) sin ( θ - π ) + {M}_{1} , \\ ( π ≦ θ < arctan ( \frac{L}{W - {W}_{1}} ) + π ) & ( Formula 30 )\end{matrix}$$

A path length of the path I from the virtual plane VP to the main sound receiving unit 11 is expressed by the following Formula 31.

[Numerical Formula 27]

(L+H)sin(θ−π)+D+H+M₁ (Formula 31)

A path length of the path J from the virtual plane VP to the main sound receiving unit 11 is expressed by the following Formula 32.

[Numerical Formula 28]

D cos(θ−π)+L+M₁ (Formula 32)

A path length of the path E from the virtual plane VP to the sub-sound receiving unit 12 is expressed by the following Formula 33.

[Numerical Formula 29]

(D−N)cos(θ−π)+M₂ (Formula 33)

When 3π/2≦θ<2π

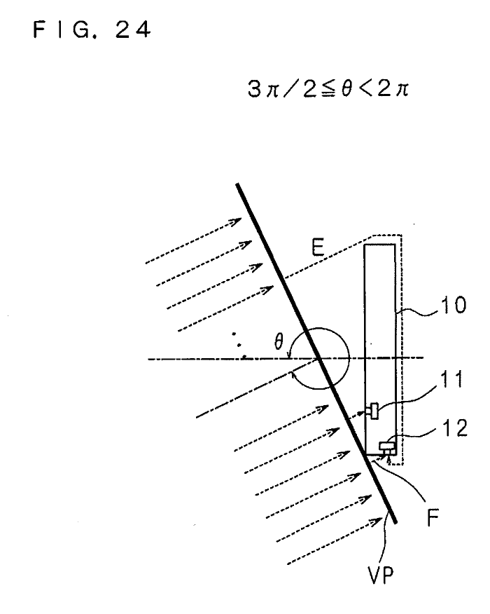

FIG. 24 is a side view conceptually illustrating a positional relation in 3π/2≦θ<2π between the virtual plane VP and the sound receiving device 1 according to Embodiment 2. The path E is a path reaching the sub-sound receiving unit 12 on the bottom face from the upper side of the housing 10 through the back face, and the path F is a path reaching the sub-sound receiving unit 12 on the bottom face of the housing 10.

When the sound receiving device 1 and the virtual plane VP have the relation illustrated in FIG. 24, a path length from the virtual plane VP to the main sound receiving unit 11 is expressed by the following Formula 34.

[Numerical Formula 30]

L sin(2π−θ)+M₁ (Formula 34)

A path length of the path E from the virtual plane VP to the sub-sound receiving unit 12 is expressed by the following Formula 35.

[Numerical Formula 31]

(L+H)sin(2π−θ)+D+L+H+D−N+M₂ (Formula 35)

A path length of the path F from the virtual plane VP to the sub-sound receiving unit 12 is expressed by the following Formula 36.

[Numerical Formula 32]

N cos(2π−θ)+M₂ (Formula 36)

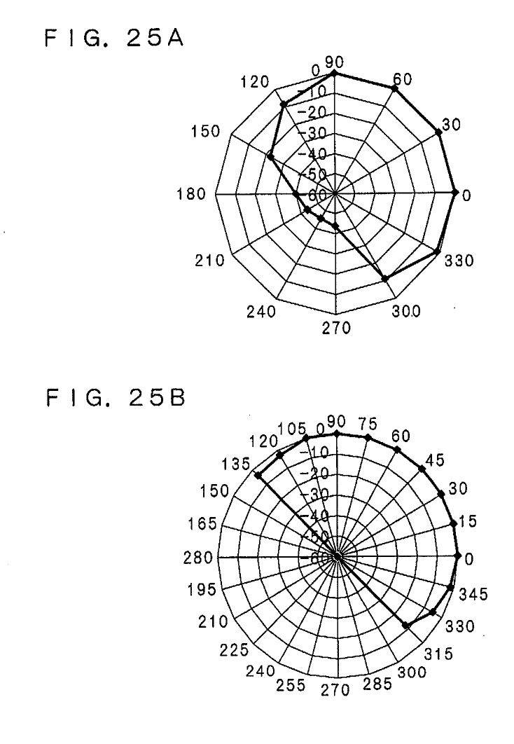

FIGS. 25A and B are radar charts illustrating a vertical directional characteristic of the sound receiving device 1 according to Embodiment 2. FIGS. 25A and B illustrate a directional characteristic for the housing 10 of the sound receiving device 1 having the sizes indicated in FIGS. 2 and 3 according to Embodiment 1. FIG. 25A illustrates a measurement result obtained by an actual measurement, and FIG. 25B illustrates a simulation result of the directional characteristic derived by the above method. The radar charts indicate signal intensities (dB) obtained after the sound received by the sound receiving device 1 is suppressed for every arriving direction of the sound. FIG. 25A illustrates a signal intensity in an arriving direction for every 30°, and FIG. 25B illustrates a signal intensity in an arriving direction for every 15°. As illustrated in FIG. 25, it is apparent that both the simulation result and the actual measurement value have strong directional characteristics in a direction of the front face, and a sound from behind is suppressed. It can be read that the simulation result reproduces a direction in which directivity is realized in the actual measurement value.

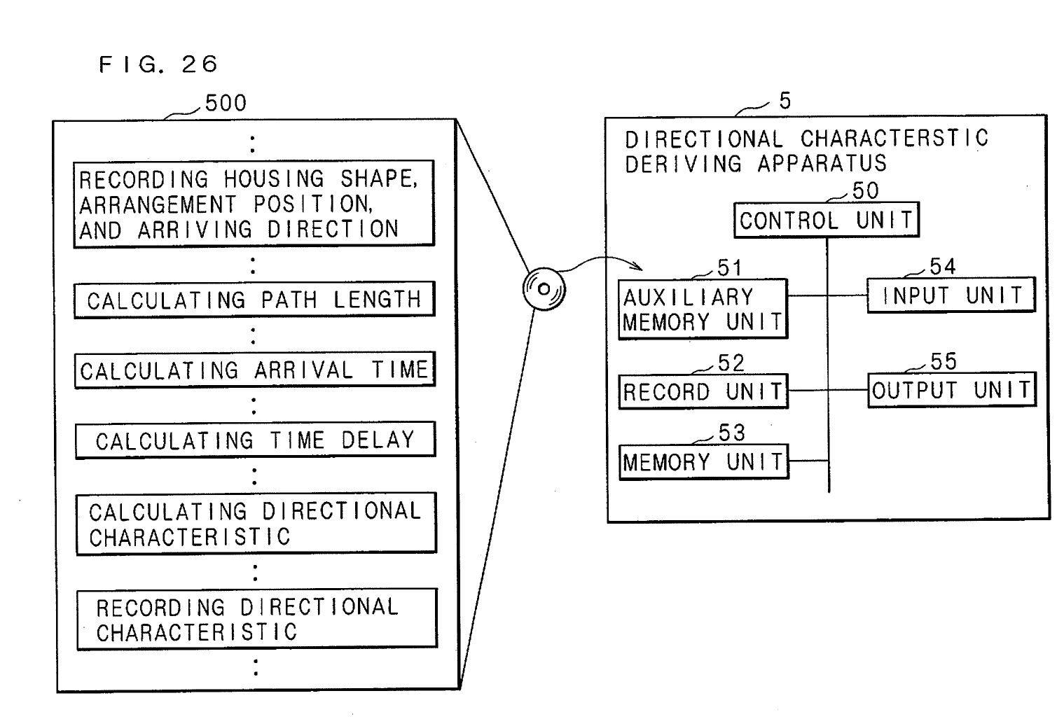

An apparatus which executes the above simulation will be described below. The simulation described above is executed by a directional characteristic deriving apparatus 5 using a computer such as a general-purpose computer. FIG. 26 is a block diagram illustrating one configuration of the directional characteristic deriving apparatus 5 according to Embodiment 2. The directional characteristic deriving apparatus 5 includes a control unit 50 such as a CPU which controls the apparatus as a whole, an auxiliary memory unit 51 such as a CD-ROM (or DVD-ROM) drive which reads various pieces of information from a recording medium such as a CD-ROM on which various pieces of information such as a computer program 500 and data for the directional characteristic deriving apparatus according to the present embodiment, a recording unit 52 such as a hard disk which reads the various pieces of information read by the auxiliary memory unit 51, and a memory unit 53 such as a RAM which temporarily stores information. The computer program 500 for the present embodiment recorded on the recording unit 52 is stored in the memory unit 53 and executed by the control of the control unit 50, so that the apparatus operates as the directional characteristic deriving apparatus 5 according to the present embodiment. The directional characteristic deriving apparatus 5 further includes an input unit 54 such as a mouse or a keyboard and an output unit 55 such as a monitor and a printer.

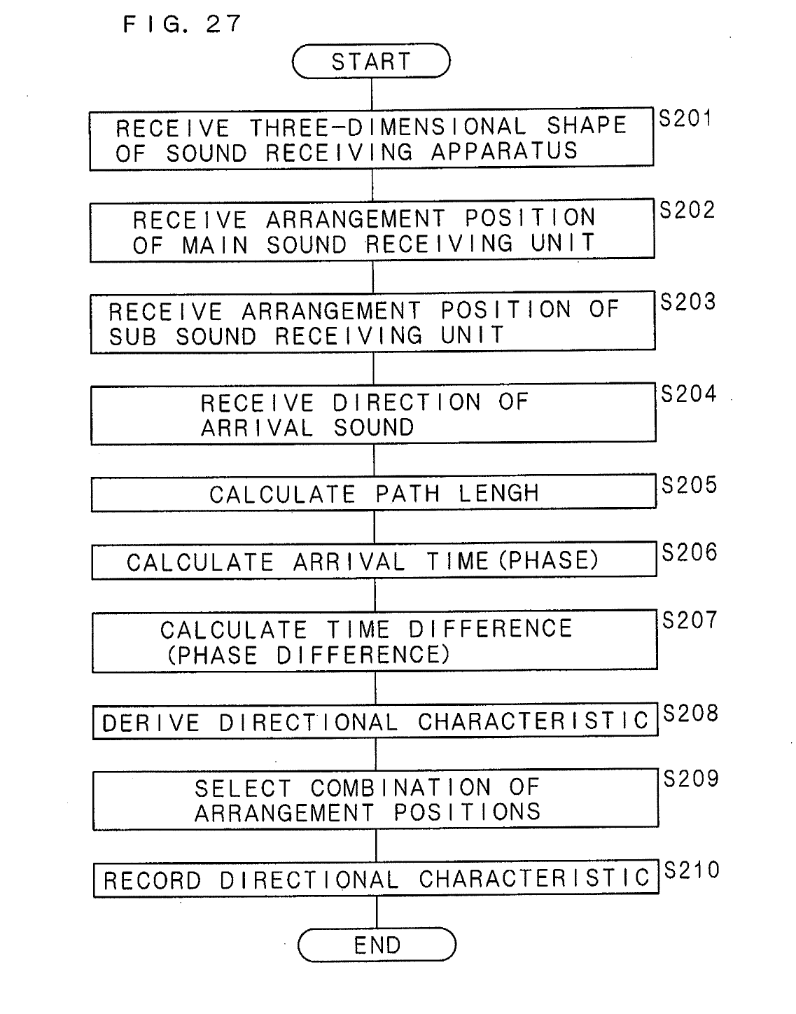

Processes of the directional characteristic deriving apparatus 5 will be described below. FIG. 27 is a flow chart illustrating processes of the directional characteristic deriving apparatus 5 according to Embodiment 2. The directional characteristic deriving apparatus 5, under the control of the control unit 50 which executes the computer program 500, accepts information representing a three-dimensional shape of a housing of a sound receiving device from the input unit 54 (S201), accepts information representing an arrangement position of an omni-directional main sound receiving unit arranged in the housing (S202), accepts information representing an arrangement position of an omni-directional sub-sound receiving unit arranged in the housing (S203), and accepts information representing a direction of an arriving sound (S204). Steps S201 to S204 are processes of accepting conditions for deriving a directional characteristic.

The directional characteristic deriving apparatus 5, under the control of the control unit 50, assumes that, when arriving sounds reach the housing, the sounds reach the main sound receiving unit and the sub-sound receiving unit through a plurality of paths along the housing, and calculates path lengths of the paths to the main sound receiving unit and the sub-sound receiving unit with respect to a plurality of arriving directions of the sounds (S205). When it is assumed that the sounds reaching the main sound receiving unit or the sub-sound receiving unit through the paths reach the main sound receiving unit or the sub-sound receiving unit as one synthesized sound, the directional characteristic deriving apparatus 5 calculates a time required for the reaching (S206). Based on a phase corresponding to the calculated time required for the reaching, with respect to each of arriving directions, the directional characteristic deriving apparatus 5 calculates a time difference (phase difference) between a sound receiving time of the sub-sound receiving unit and a sound receiving time of the main sound receiving unit as a delay time (S207). Based on a relation between the calculated delay time and the arriving direction, the directional characteristic deriving apparatus 5 derives a directional characteristic (S208). The processes in steps S205 to S208 are executed by the simulation method described above.

The directional characteristic deriving apparatus 5, under the control of the control unit 50, selects a combination of arrangement positions of the main sound receiving unit and the sub-sound receiving unit in which the derived directional characteristic satisfies given conditions (S209) and records the directional characteristic on the recording unit 52 in association with the selected arrangement positions of the main sound receiving unit and the sub-sound receiving unit (S210). In step S209, a setting of a desired directional characteristic is pre-recorded on the recording unit 52 as the given conditions. For the given conditions, when the angle of the front face is set to 0° for example, the center of the directivity ranging within 0±10° is set as a numerical condition which regulates that a directivity is not inclined, and an amount of suppression in directions at angles of 90° and 270° is set to 10 dB or more as a numerical condition which regulates that a sound arriving from a direction of the side face is largely suppressed. Also, the amount of suppression in a direction at an angle of 180° is set to 20 dB or more as a numerical condition which regulates that a sound arriving from a direction to the back face is largely suppressed, and the amount of suppression within 0±30° is set to 6 dB or less as a numerical condition which regulates prevention of sharp suppression for a shift in a direction of the front face. With the selection made in step S209, in order to design a sound receiving device having a desired directional characteristic, candidates of the arrangement positions of the main sound receiving unit and the sub-sound receiving unit may be extracted. The arrangement positions of the main sound receiving unit and the sub-sound receiving unit and the directional characteristic recorded in step S210 are output as needed. This allows a designer to examine the arrangement positions of the main sound receiving unit and the sub-sound receiving unit for realizing the desired directional characteristic.

Embodiment 2 described above describes the configuration in which a rectangular parallelepiped housing having the two sound receiving units arranged therein is simulated. The present embodiment is not limited to the configuration. One configuration which uses three or more sound receiving units may also be employed. The configuration may be developed into various configurations such that a housing with a shape other than a rectangular parallelepiped shape is simulated.

### Embodiment 3

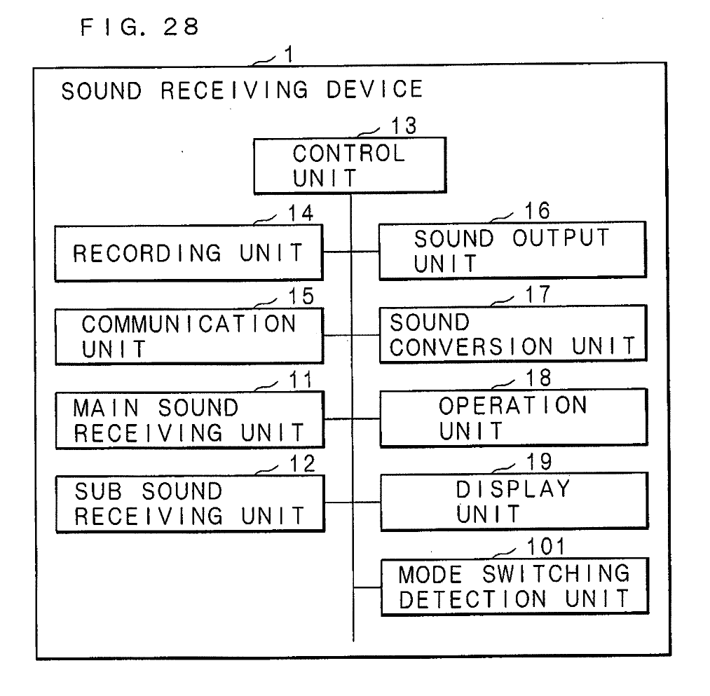

Embodiment 3 is one configuration in which, in Embodiment 1, a directional characteristic is changed when a mode is switched to a mode such as a videophone mode having a different talking style. FIG. 28 is a block diagram illustrating one configuration of a sound receiving device according to Embodiment 3. In the following explanation, the same reference numerals as in Embodiment 1 denote the same constituent elements as in Embodiment 1, and a description thereof will not be repeated.

The sound receiving device 1 according to Embodiment 3 includes a mode switching detection unit 101 which detects that modes are switched. A mode switching unit detects that a mode is switched to a mode having a different talking style when a normal mode which performs speech communication as normal telephone communication is switched to a videophone mode which performs video and speech communication, or when the reverse switching is performed. In the normal mode, since a talking style in which a speaker speaks while causing her/his mouth to be close to the housing 10 is used, directional directions are narrowed down. In a videophone mode, since a talking style in which a speaker speaks while watching the display unit 19 of the housing 10 is used, the directional directions are widened up. The switching of the directional directions is performed by changing the first threshold thre1 and the second threshold thre2 which determine a suppression coefficient gain(ω).

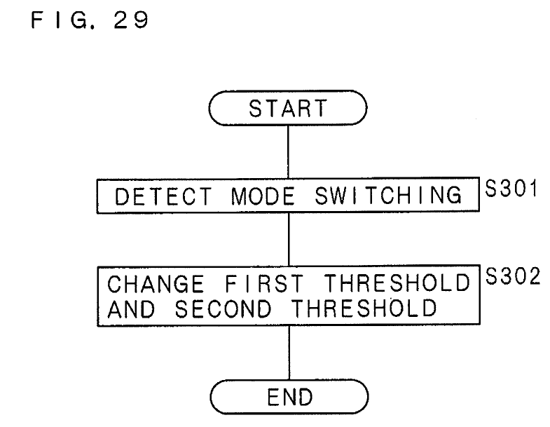

FIG. 29 is a flow chart illustrating an example of processes of the sound receiving device 1 according to Embodiment 3. The sound receiving device 1, under the control of the control unit 13, when the mode switching detection unit 101 detects that a mode is switched to another mode with a different talking style (S301), changes the first threshold thre1 and the second threshold thre2 (S302). For example, when the normal mode is switched to the videophone mode, a given signal is output from the mode switching detection unit 101 to the suppression coefficient calculation unit 143. In the suppression coefficient calculation unit 143, based on the accepted signal, the first threshold thre1 and the second threshold thre2 are changed to those for the videophone mode to realize the processes.

As an example of the first threshold thre1 and the second threshold thre2, the first threshold thre1=−0.7 and the second threshold thre2=0.05 set for the normal mode are changed to the first threshold thre1=−0.7 and the second threshold thre2=0.35 set for the videophone mode. Since an unsuppressed angle is increased by the change, directivity is widened. Even if speech modes change, the voice of a speaker may be prevented from being suppressed. Instead of changing the first threshold thre1 and the second threshold thre2 to given values, the first threshold thre1 and the second threshold thre2 may be automatically adjusted such that a voice from a position of the mouth of a speaker which is estimated from a phase difference of sounds received after the mode change is not suppressed.

Embodiment 3 above describes the configuration in which, when a mode is switched to the videophone mode, suppression coefficients are changed to change directional characteristics. However, the present embodiment is not limited to the configuration. The present embodiment may also be applied when the normal mode is switched to a hands-free mode or the like having a talking style different from that of the normal mode.

Embodiments 1 to 3 above describe the configurations in which the sound receiving devices are applied to mobile phones. However, the present embodiment is not limited to the configurations. The present embodiment may also be applied to various devices which receive sounds by using a plurality of sound receiving units arranged in housings having various shapes.

Each of Embodiments 1 to 3 above describes the configuration with one main sound receiving unit and one sub-sound receiving unit. However, the present embodiment is not limited to such configuration. A plurality of main sound receiving units and a plurality of sub-sound receiving unit may also be arranged.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A sound receiving device including a housing in which a plurality of omni-directional sound receiving units which is able to receive sounds arriving from a plurality of directions are arranged, comprising:
at least one main sound receiving unit;
at least one sub-sound receiving unit arranged at a position to receive a sound, arriving from a direction other than a given direction, earlier by a given time than the time when the main sound receiving unit receives the sound;
a calculation unit which, with respect to the received sounds, calculates a time difference, as a delay time, between a sound receiving time of the sub-sound receiving unit and a sound receiving time of the main sound receiving unit; and
a suppression enhancement unit which carries out suppression of the sound received by the main sound receiving unit in the case where the calculated delay time is no less than a threshold and/or enhancement of the sound received by the main sound receiving unit in the case where the calculated delay time is shorter than the threshold.

2. The sound receiving device according to claim 1, wherein the housing includes:
one sound receiving face on which the main sound receiving unit is arranged; and
a contact face which is in contact with the sound receiving face, wherein
the sub-sound receiving unit is arranged on the contact face.

3. The sound receiving device according to claim 1, wherein the housing includes:
one sound receiving face on which the main sound receiving unit and the sub-sound receiving unit are arranged, wherein
the sub-sound receiving unit is arranged at a position where a minimum distance to an edge of the sound receiving face is shorter than that of the main sound receiving unit.

4. The sound receiving device according to claim 1, wherein
the enhancement suppression unit enhances a sound received by the main sound receiving unit or prevents the sound received by the main sound receiving unit from being suppressed, when the delay time representing the difference between the sound receiving time of the sub-sound receiving unit and the sound receiving time of the main sound receiving unit is maximum.

5. The sound receiving device according to claim 1, wherein
the sound receiving device is incorporated in a mobile phone.

6. The sound receiving device according to claim 5, wherein
the mobile phone performs speech communication or video and speech communication, and
the sound receiving device further includes:
a switching unit which switches the speech communication and the video and speech communication; and
a unit which changes values related to the threshold of the suppression enhancement unit depending on switching performed by the switching unit.

7. A directional characteristic deriving method using a directional characteristic deriving apparatus which derives a relation between a directional characteristic and arrangement positions of a plurality of omni-directional sound receiving units arranged in a housing of a sound receiving device, comprising:
accepting information representing a three-dimensional shape of the housing of the sound receiving device;
accepting information representing an arrangement position of an omni-directional main sound receiving unit arranged in the housing;
accepting information representing an arrangement position of an omni-directional sub-sound receiving unit arranged in the housing;
accepting information representing a direction of an arriving sound;
assuming that the sounds reach the main sound receiving unit and the sub-sound receiving unit through a plurality of paths along the housing when arriving sounds reach the housing, calculating path lengths of the paths to the main sound receiving unit and the sub-sound receiving unit with respect to a plurality of arriving directions of the sounds;
calculating a time required to reach based on the calculated path lengths, when it is assumed that the sounds reaching the main sound receiving unit or the sub-sound receiving unit through the paths reach the main sound receiving unit or the sub-sound receiving unit as one synthesized sound;
calculating a time difference between a sound receiving time of the sub-sound receiving unit and a sound receiving time of the main sound receiving unit as a delay time with respect to the arriving directions based on the calculated time required for the reaching;
deriving a directional characteristic based on a relation between the calculated delay time and the arriving direction; and
recording the derived directional characteristic in association with the arrangement positions of the main sound receiving unit and the sub-sound receiving unit.

8. A directional characteristic deriving apparatus which derives a relation between a directional characteristic and arrangement positions of a plurality of omni-directional sound receiving units arranged in a housing of a sound receiving device, comprising:
a first accepting unit which accepts information representing a three-dimensional shape of the housing of the sound receiving device;
a second accepting unit which accepts information representing an arrangement position of an omni-directional main sound receiving unit arranged in the housing;
a third accepting unit which accepts information representing an arrangement position of an omni-directional sub-sound receiving unit arranged in the housing;
a fourth accepting unit which accepts information representing a direction of an arriving sound;
a first calculation unit which, assuming that the sounds reach the main sound receiving unit and the sub-sound receiving unit through a plurality of paths along the housing when arriving sounds reach the housing, calculates path lengths of the paths to the main sound receiving unit and the sub-sound receiving unit with respect to a plurality of arriving directions of the sounds;
a second calculation unit which, based on the calculated path lengths, when it is assumed that the sounds reaching the main sound receiving unit or the sub-sound receiving unit through the paths reach the main sound receiving unit or the sub-sound receiving unit as one synthesized sound, calculates a time required for the reaching;
a third calculation unit which, based on the calculated time required for the reaching, with respect to the arriving directions, calculates a time difference between a sound receiving time of the sub-sound receiving unit and a sound receiving time of the main sound receiving unit as a delay time;
a deriving unit which derives a directional characteristic based on a relation between the calculated delay time and the arriving direction; and
a recording unit which records the derived directional characteristic in association with the arrangement positions of the main sound receiving unit and the sub-sound receiving unit.

9. A computer readable recording medium on which a program which derives a relation between a directional characteristic and arrangement positions of a plurality of omni-directional sound receiving units arranged in a housing of a sound receiving device is recorded, the program comprising:
recording information representing a three-dimensional shape of the housing of the sound receiving device, information representing an arrangement position of an omni-directional main sound receiving unit arranged in the housing, information representing an arrangement position of an omni-directional sub-sound receiving unit arranged in the housing, and information representing a direction of an arriving sound;
assuming that the sounds reach the main sound receiving unit and the sub-sound receiving unit through a plurality of paths along the housing when arriving sounds reach the housing, calculating path lengths of the paths to the main sound receiving unit and the sub-sound receiving unit with respect to a plurality of arriving directions of the sounds;
calculating a time required to reach based on the calculated path lengths, when it is assumed that the sounds reaching the main sound receiving unit or the sub-sound receiving unit through the paths reach the main sound receiving unit or the sub-sound receiving unit as one synthesized sound;
calculating a time difference between a sound receiving time of the sub-sound receiving unit and a sound receiving time of the main sound receiving unit as a delay time with respect to the arriving directions based on the calculated time required for the reaching;
deriving a directional characteristic based on a relation between the calculated delay time and the arriving direction; and
recording the derived directional characteristic in association with the arrangement positions of the main sound receiving unit and the sub-sound receiving unit.
